(19) United States
(12) Patent Application Publication
(10) Pub. No.: US 2026/0130823 A1
(43) Pub. Date: May 14, 2026

(54) METHOD AND SYSTEM FOR DETECTING OPEN STATUS OF COVER ON A BATHING UNIT AND FOR OPERATING BATHING UNIT BASED ON SAME

(71) Applicant: GECKO ALLIANCE GROUP INC., Québec (CA)

(72) Inventors: Guillaume TREMBLAY, Québec (CA); Vincent BOUCHARD, l'Ancienne-Lorette (CA); Dannik GAGNON, Trois-Rivières (CA); Jérôme LANDRY, Québec (CA)

(21) Appl. No.: 18/941,702

(22) Filed: Nov. 8, 2024

(51) Int. Cl. A61H 33/00

(52) U.S. Cl. CPC A61H 33/005; A61H 33/0087; A61H 2033/0075

(57) ABSTRACT

Disclosed are methods and systems for detecting open status of the cover on a bathing unit and for operating such a bathing unit. A topside control panel for a spa system is configured to be mounted to a peripheral wall of a water receptacle and a spa cover concurrently covers the water receptacle and the topside control panel, which has a light detection sensor proximate a user interface and measures lighting conditions on the topside control panel. A processing unit is configured to receive signals from the light detection sensor conveying the lighting conditions on the topside control panel, derive a spa cover status indicator for the spa cover, and operate the user interface in accordance with a closed cover operational process, and operate the user interface in accordance with an open cover operational process, the open cover operational process being different from the closed cover operational process.

### TECHNICAL FIELD

The present invention relates generally to the field of bathing unit systems, and more specifically, to a control panel for facilitating the control of operational settings in a bathing unit system.

### BACKGROUND

Bathing units, such as spas, typically include various bathing unit components that are used in operating the bathing system. The bathing unit components generally include pumps that circulate water through a piping system, pumps for activating water jets, at least one heating module to heat the water, a filter system, an air blower, an ozone generator, a lighting system, and a control system that activates and manages the various operational settings of the bathing unit components. Other types of bathing units that have similar components include, for instance, whirlpools, hot tubs, bathtubs, therapeutic baths, spas and swimming pools.

In general, bathing unit control systems include a controller to which the various bathing unit components are connected. This controller is adapted to adjust and control the activation and settings of the various bathing unit components. More specifically, in response to signals received from a user of the bathing unit system, for example via a control panel, and/or in response to signals received from various sensors, the controller will activate or de-activate the various bathing unit components by supplying power, or ceasing to supply power, to those components. Most modern bathing systems include a control panel that is in communication with the controller. The control panel is typically positioned in proximity to the water receptacle so that a user of the bathing system may interact with it to control bathing unit components.

While the control panel can be operated from a remote device, such as by an app on a mobile phone, the control panel typically also receives touch inputs from a user of the bathing unit. The use of touch inputs presents challenges in correctly operating of the control panel. The control panel may undesirably change into an in-use mode of operation or change other operational parameters by erroneously interpreting some touches as control inputs. For example, an object or a drop of water falling on or passing by may trigger the control panel. Detection of erroneous inputs is exacerbated by the proximity of the control panel to the water within the bathing unit. While this proximity facilitates user interactions with the control panel, the resulting exposure to moisture can cause the touch input to have increased sensitivity, and increased liability to detect incorrect inputs.

To conserve energy, most bathing unit systems also include a cover that fits over the water receptacle when the bathing unit system is not in use. Modern bathing unit systems include sensors that detect when the cover is in place or removed, such as described in U.S. Pat. No. 10,398,624, which is incorporated herein in its entirety. It would be beneficial for bathing unit systems to be able to detect and control features of the bathing unit and of the control panel specifically when the system is considered “active” and be responsive to user inputs. It would also be beneficial for bathing unit systems to adjust their settings upon determining that the system is to be considered active.

Against the background described above, there remains a need in the industry to provide a topside control panel for a bathing unit system that alleviates at least in part the problems associated with existing control panels of the type described above.

### SUMMARY

A problem sought to be addressed is to provide a control panel that facilitates automated control of a bathing unit system with a spa cover.

In accordance with a general aspect, disclosed is a topside control panel for a spa system including a water receptacle for holding water, a controller for controlling spa components in the spa system and a spa cover, the topside control panel being configured to be mounted to a peripheral wall of the water receptacle, the spa cover being configured to be in a closed position and an open position, wherein when in the closed position the spa cover is configured for concurrently covering the water receptacle and the topside control panel. The topside control panel comprises a panel body having an upper surface including a user interface for controlling operational settings of the spa system, a light detection sensor positioned on the panel body, the light detection sensor being proximate the user interface and being configured to measure lighting conditions on the topside control panel, and a processing unit in communication with the user interface and the light detection sensor. The processing unit is configured to receive signals from the light detection sensor conveying the lighting conditions on the topside control panel, derive a spa cover status indicator for the spa cover at least in part by processing the signals from the light detection sensor conveying the lighting conditions, in response to the spa cover status indicator conveying that the spa cover is in the closed position, operating the user interface in accordance with a closed cover operational process, and in response to a current cover status indicator conveying that the spa cover is in the open position, operating the user interface in accordance with an open cover operational process, the open cover operational process being different from the closed cover operational process.

Embodiments can include one or more of the following features: the user interface is a graphical user interface (GUI) and wherein the upper surface of the panel body includes a display screen displaying the GUI. The display screen is a touch screen and wherein the GUI presents user operable inputs for providing user commands for controlling at least some of the operational settings of the spa system. The closed cover operational process includes disabling at least in part the user interface. The open cover operational process includes transmitting a control signal to the spa controller for causing the spa controller to implement specific operational settings for the spa system conveyed by specific user commands provided via the user interface. Disabling at least in part the user interface includes disabling the touch screen. Operating the user interface in accordance with the closed cover operational process includes setting a sensitivity to touch of the touch screen to a first sensitivity level and wherein operating the user interface in accordance with the open cover operational process includes setting the sensitivity to touch of the touch screen to a second sensitivity level, the second sensitivity level being higher than the first sensitivity level so that there the touch screen is more sensitive when the spa cover is in the open position than when in the closed position. The processing unit is configured for adjusting a level of brightness of the display screen at least in part by processing the spa cover status indicator. Adjusting the level of brightness of the display screen includes: setting the level of brightness of the display screen to a first brightness level in response to the current cover status indicator conveying that the spa cover is in the open position, and setting the level of brightness of the display screen to a second brightness level in response to the current cover status indicator conveying that the spa cover is in the closed position, the second brightness level being lower than the first brightness level. The processing unit is configured for: receiving signals from a second light sensor conveying measurements of ambient lighting conditions for the spa system, and adjusting the level of brightness of the display screen at least in part by processing the spa cover status indicator and the signals received from the second light sensor. The processing unit is configured for: receiving signals from a second light sensor conveying measurements of ambient lighting conditions for the spa system, deriving light calibration information at least in part by processing the measurements of ambient lighting conditions for the spa system, and deriving the spa cover status indicator for the spa cover at least in part by processing the signals from the light detection sensor conveying the lighting conditions and the light calibration information. Communication between the processing unit and the light detection sensor is wireless and/or wired. The light detection sensor is configured to measure at least one of visible light and infrared light. The light detection sensor is positioned on the upper surface of the panel body, or on a side surface of the panel body.

In accordance with a general aspect, disclosed is a control system for a spa system including a water receptacle for holding water and a spa cover, the spa cover being configured to be in a closed position and an open position, wherein when in the closed position the spa cover is configured for concurrently covering the water receptacle and a peripheral wall of the water receptacle, the control system including: a topside control panel being configured to be mounted to the peripheral wall of the water receptacle, the topside control panel comprising: a panel body having an upper surface including a user interface for controlling operational settings of the spa system, and a light detection sensor positioned on the panel body, the light detection sensor being proximate the user interface and being configured to measure lighting conditions on the topside control panel, and one or more processors in communication with the topside control panel. The one or more processors being configured for: receiving signals from the light detection sensor conveying the lighting conditions on the topside control panel, processing the signals from the light detection sensor conveying the lighting conditions to derive a spa cover status indicator for the spa cover, processing information conveying current operational settings of the spa system and the spa cover status indicator for detecting inconsistencies between the current operational settings of the spa system and the spa cover, and in response to detection of specific inconsistencies, performing an inconsistency management process, the inconsistency management process including at least one of: issuing a notification to a user device conveying a presence of inconsistencies, causing the operational settings of the spa system to be set to standby settings or error settings.

Embodiments can include one or more of the following features: the user device includes a display screen and wherein the notification includes an error message displayed on the display screen. The user device is a personal communication device in communication with the control system over a network. The presence of inconsistencies is detected when the spa cover status indicator conveys that the cover is in the open position and the operational settings of the spa system convey that the spa system is in a prolonged rest mode. The prolonged rest mode is one of a hibernation mode and an away mode. The presence of inconsistencies is detected when the spa cover status indicator conveys that the cover is in the closed position and the operational settings of the spa system convey that the spa system is in an active use mode, wherein the use active mode includes an activation of at least one of jets and water pump. Causing the operational settings of the spa system to be set to standby settings or error settings includes at least one of: causing one or more spa components in the spa system to acquire a deactivate state, and activating a visual indicator on or in proximity to the topside control panel to convey the presence of inconsistencies in connection with the spa cover, the visual indicator being in communication with the one or more processors. The light detection sensor is positioned on the upper surface of the panel body, or on a side surface of the panel body.

In accordance with a general aspect, disclosed is a topside control panel for a spa system including a water receptacle for holding water, a spa controller for controlling spa components in the spa system and a spa cover, the topside control panel being configured to be mounted to a peripheral wall of the water receptacle, the spa cover being configured to de displaced from a closed position to an open position and from the closed position to the open position, wherein when in the closed position the spa cover is configured for concurrently covering the water receptacle and the topside control panel, the topside control panel comprising: a panel body having an upper surface including a user interface for controlling operational settings of the spa system, a light detection sensor positioned on the panel body, the light detection sensor being proximate the user interface and being configured to measure lighting conditions on the topside control panel, and a processing unit in communication with the user interface and the light detection sensor. the processing unit being configured to: receive signals from the light detection sensor conveying the lighting conditions on the topside control panel, processing the signals from the light detection sensor conveying the lighting conditions on the topside control panel to detect occurrences of transitions in a spa cover status from one of: the closed position to the open position, and the open position to the closed position, the transitions in the spa cover status being detected at least in part by processing changes in the lighting conditions on the topside control panel, and in response to detection of a specific transition in the spa cover status, transmitting a control signal for causing the spa controller to implement specific corresponding operational settings in the spa system, the specific corresponding operational settings being derived at least in part by processing the specific transition detected.

Embodiments can include one or more of the following features: when the specific transition in the spa cover status is from the closed position to the open position, the specific corresponding operational settings are derived from a specific ambience setting. The specific ambience setting conveys operational setting for spa components of at least two different types in the spa system, the at least two different types being selected from amongst lighting components, a pump, jets, audio components, video components and a heater. The specific ambience setting conveys light setting for a perimeter of the bathing system and pump settings. The specific ambience setting is selected from a plurality of ambience settings, and wherein the selection is performed at least in part by processing the specific transition detected in combination with at least one other factor. The at least one other factor includes one of a user identifier, time of day information, day of week information, season information and weather information. When the specific transition in the spa cover status is from the closed position to the open position, the specific corresponding operational settings corresponds to a set of operational settings last used when operating the spa system. The specific transition in the spa cover status is from the open position to the closed position, the specific corresponding operational settings correspond to a specific energy savings setting. The specific energy savings setting is selected from a plurality of energy savings settings, and wherein the selection is performed at least in part by processing the specific transition detected in combination with at least one other factor. The at least one other factor includes one of a user preference information, time of day information, day of week information, season information, energy cost information and weather information. The light detection sensor is positioned on the upper surface of the panel body. The processing unit is configured for: receiving signals from a second light sensor conveying measurements of ambient lighting conditions for the spa system, deriving light calibration information at least in part by processing the measurements of ambient lighting conditions for the spa system, and detecting occurrences of transitions in the spa cover status in part by processing the signals from the light detection sensor conveying the lighting conditions on the topside control panel and the light calibration information.

In accordance with a general aspect, disclosed is a topside combination for a spa system, the spa system including a water receptacle for holding water, a spa controller for controlling spa components in the spa system and a spa cover, the spa cover being configured to be in a closed position, in a fully opened position and in one or more partially opened positions, wherein when in the closed position the spa cover is configured for concurrently covering the water receptacle and a peripheral wall of the water receptacle, the topside combination comprising: a first member configured to be mounted at a first location on the peripheral wall of the water receptacle, the first member including a topside control panel having an upper surface with a user interface for controlling operational settings of the spa system, wherein a first light detection sensor is positioned on the first member, the first light detection sensor being proximate the user interface and being configured to measure lighting conditions on the topside control panel, a second member configured to be positioned at a second location on the peripheral wall of the water receptacle, the second location on the peripheral wall being spaced apart from the first location on the peripheral wall, the second member including a second light detection sensor configured to measure lighting conditions at the second location on the peripheral wall, and a processing unit in communication with the first member and the second member. The processing unit being configured to: receive signals from the first light detection sensor and the second light detection sensor conveying the lighting conditions on the topside control panel and the lighting conditions at the second location on the peripheral wall, processing the signals received to derive a spa cover status indicator for the spa cover, in response to the spa cover status indicator conveying that the spa cover is in the closed position, transmitting control signals causing the spa controller to operate the spa system in accordance with a closed cover operational process, and in response to the spa cover status indicator failing to convey that the spa cover is in the closed position, transmitting control signals causing the spa controller to operate the spa system in accordance with one of an open cover operational process and a partially open cover operational process.

Embodiments can include one or more of the following features: the second location on the peripheral wall is opposite the first location on the peripheral wall. The spa cover status indicator for the spa cover is configured to convey that: the spa cover is in the closed position, the spa cover is in the open position, or that the spa cover in one of the one or more partially opened positions. The processing unit is configured to derive the spa cover status indicator conveying that the spa cover in the one of the one or more partially opened positions at least in part by processing differences between the lighting conditions at the second location and the lighting conditions on the topside control panel. The first member is a first topside control panel, the second member comprising a second topside control panel, the second light detection sensor being part of the second control panel. The first light detection sensor is positioned on the upper surface of the first member or on a side surface of the first member and the second light detection sensor is positioned on the upper surface of the second member or on a side surface of the second member.

In accordance with a general aspect, disclosed is a topside control panel for a spa system including a water receptacle for holding water, a spa controller for controlling spa components in the spa system and a spa cover, the spa cover being configured to be in a closed position, in a fully opened position and in a partially opened position, wherein when in the closed position the spa cover is configured for concurrently covering the water receptacle and the topside control panel, the topside control panel comprising: a panel body having an upper surface including a user interface for controlling operational settings of the spa system, a first light detection sensor positioned on the panel body, the first light detection sensor being proximate the user interface and being configured to measure lighting conditions at a first location on the topside control panel, a second light detection sensor positioned on the panel body, the second light detection sensor being proximate the user interface and being configured to measure lighting conditions at a second location on the topside control panel, the second location being spaced apart from the first location. When in the partially opened position the spa cover covers one of the first location and second location on the topside control panel and fails to cover an other one of the first location and second location on the topside control panel, when in the opened position, the spa cover fails to cover the first location on the topside control panel and the second location on the topside control panel, when in the closed position, the spa cover the first location on the topside control panel and the second location on the topside control panel, and a processing unit in communication with the first light detection sensor and the second light detection sensor. The processing unit being configured to: receive signals from the first light detection sensor and the second light detection sensor conveying the lighting conditions at the first location and at the second location on the topside control panel, processing the signals received to derive a spa cover status indicator for the spa cover, in response to the spa cover status indicator conveying that the spa cover is in the closed position, transmitting control signals causing the spa controller to operate the spa system in accordance with a closed cover operational process, and in response to the spa cover status indicator failing to convey that the spa cover is in the closed position, transmitting control signals causing the spa controller to operate the spa system in accordance with one of an open cover operational process and a partially open cover operational process.

Embodiments can include one or more of the following features: the partially open cover operational process comprises sending an alert to a user device to convey the status of the spa cover. The user interface is a graphical user interface (GUI) and wherein the upper surface of the panel body includes a display screen displaying the GUI. The display screen is a touch screen and wherein the GUI presents user operable inputs for providing user commands for controlling at least some of the operational settings of the spa system. The first detection sensor and the second light detection sensor are located on opposite sides of the touch screen. One or both of the first light detection sensor and the second light detection sensor is positioned on the upper surface of the panel body. One or both of the first light detection sensor and the second light detection sensor is positioned on a side surface of the panel body

In accordance with a general aspect, disclosed is a method of controlling a spa system including a topside control panel, a water receptacle for holding water, a controller for controlling spa components in the spa system and a spa cover, the topside control panel having an interface and a light detection sensor positioned proximate to the interface and being configured to be mounted to a peripheral wall of the water receptacle, the spa cover being configured to be in a closed position and an open position, wherein when in the closed position the spa cover is configured for concurrently covering the water receptacle and the topside control panel, the method being implemented by one or more processors and comprising: deriving spa cover status indicators conveying open and closed status information for the spa cover at least in part by processing signals received over time from the light detection sensor conveying the lighting conditions at the topside control panel, storing historical data about the open or closed status of the spa cover conveyed by the spa cover status indicators on a computer readable medium, operating the spa system including at least one of: adjusting operations of one of more components of the spa system at least in part by processing the historical data about the open or closed status of the spa cover, transmitting at least part of the historical data to a remote device to derive information pertaining to usage information of the spa system, and transmitting notifications to one or more remote devices at least in part based on results derived by processing the historical data.

Embodiments can include one or more of the following features: adjusting the operations of one of more components of the spa system includes adjusting a sanitation schedule of the spa system. Transmitting notifications to the one or more remote devices includes sending an alert to a user device in response to the historical data conveying a duration of the spa open status exceeding a safety threshold. Transmitting notifications to the one or more remote devices includes transmitting a notification conveying a hardware warranty expiry for the topside control panel at least in part by: processing the historical data to derive an indication of sun exposure duration, and in response to the indication of sun exposure duration exceeding a threshold exposure limit, transmitting the notification conveying the hardware warranty expiry. Transmitting at least part of the historical data to the remote device to validate a warranty of the spa cover based on a duration of the closed status of the spa cover. Transmitting at least part of the historical data to the remote device to derive a usage fee for the spa system.

In accordance with a general aspect, disclosed is a topside control panel for a bathing unit system, comprising: a user interface including a touch screen, a light detection sensor proximate the touch screen that is configured to detect if light falling on the light detection sensor on above or below a threshold, and a processor electrically coupled to the touch screen and configured to receive a signal from the light detection sensor and thereby determine if a spa cover is in an open configuration or a closed configuration and modify the user interface in response.

In accordance with another aspect, a topside control panel for a spa system having a spa tube and spa controller is provided, wherein the topside control panel is equipped with one or more light sensors. The one or more light sensors can be configured to either measure ambient light or infrared light. A spa cover is used to cover the top of the spa tub. When the spa tub is covered by the spa cover, the spa cover also covers the topside control panel. The detection of the presence or absence of light by the one or more light sensors on the topside control panel is used to trigger a signal conveying that the cover of the spa is closed or open (or partially open), and thus that the spa in not use when the cover is closed. The signal may be provided to the spa controller to modulate the behavior of the spa controller at least in part in dependence of the open/closed status of the spa cover. If the signal conveys that the spa cover is closed, and thus that the spa is not in use, the spa controller may be configured to operate in a stand-by mode, including an energy efficiency mode. In addition, the topside control panel may also be configured to operate in a stand-by mode, for example by not responding to any detected touches on a touchscreen on the topside control panel. If the signal conveys that the spa cover is open (or partially open), the topside control panel may be configured to operate in an active mode, for example by changing the brightness of the screen and/or responding to detected touches on the touchscreen on the topside control panel. In addition, the controller may operate in active modes, including starting operations of one or more bathing unit components (e.g. lights, jets, pumps, audio, others) and/or ambience settings.

Alternatively, or in addition, the signal conveying that the cover of the spa is closed or open (or partially open) may be provided to the spa controller to collect data about spa usage based on cover opening/closing time duration. The data may then be processed either by the controller or by a computing system in communication with the spa controller to selectively send alerts to the user about spa use, manage warranties, assess rental billings and other features.

In some variants, the topside control panel may be configured for detecting when the spa cover is partially opened and, optionally, the extent of the partial opening using one or more of the light sensors. Various suitable methods for detecting if the cover is partially open maybe contemplated, including for example using two different control panel with integrated light sensors at opposite sides of the tub, using two sensors on the same control panel, and providing a learning or calibration mode to teach the processor what a partially opened brightness reading may look like.

In some variants, and additional light sensor may be provided on the spa body at a location that is not covered by the spa covered when in the closed position or open position. Data from this additional light sensor may be collected for determining characteristics of ambient light outside the spa that can be used to calibrate the light measurements obtained by the one or more of the light sensors on the topside control panel to account for ambient light (for example night-time/day-time use, etc.).

In accordance with another aspect, a topside control panel having a light detection sensor positioned thereon is provided, wherein during use the topside control panel can be covered and uncovered by a spa cover, and wherein the operation of the topside control panel is modulated as a result of signals obtained from the light detection sensor. For example, based on the signals from the light detection sensor, the system may be configured to select and activate specific settings associated with the spa being non-operational or operational, including increasing or blocking the sensitivity of the touch screen, changing the brightness of the topside control panel screen, starting preprogrammed ambience settings, or ignoring touch inputs due to the spa not being in use.

In accordance with another aspect, methods of determining if the cover is partially open are provided. In accordance with another aspect, methods of using data collected on spa cover opening/closing times are described, including managing warranties based on keypad sunlight exposure and/or moisture control of the cover, and automatic billing of rentals having the spa.

All features of embodiments which are described in this disclosure and are not mutually exclusive can be combined with one another. Elements of one embodiment can be utilized in the other embodiments without further mention. Other aspects and features of the present invention will become apparent to those ordinarily skilled in the art upon review of the following description of specific embodiments in conjunction with the accompanying Drawings.

### BRIEF DESCRIPTION OF THE DRAWINGS

A detailed description of the embodiments of the present invention is provided herein below, by way of example only, with reference to the accompanying drawings, in which:

FIG. 1 shows a block diagram of a bathing system equipped with a control panel according to an embodiment;

FIG. 2 shows a functional block diagram of the control panel of the bathing system of FIG. 1 including a user interface module with an integrated light detection sensor and a processing assembly according to an embodiment;

FIGS. 3A and 3B are diagrams of the control panel of FIG. 2 showing two different implementations of a first specific example of the user interface module;

FIGS. 4A and 4B are diagrams of the control panel of FIG. 2 showing two different implementations of a second specific example of the user interface module;

FIGS. 5A-5C show an embodiment of a bathing unit on which is installed a topside control panel with a light detection sensor, and with a spa cover in various configurations;

FIG. 6 shows a second embodiment of a bathing unit on which is installed two topside control panels with light detection sensors, and with a spa cover;

FIGS. 7A and 7B show a third embodiment of a bathing unit on which is installed a topside control panel with light detection sensors, and a spa cover in various configurations;

FIG. 8 shows an additional embodiment of a bathing unit having an ambient light sensor on the outer peripheral wall and a spa cover;

FIG. 9-12 are flowcharts illustrating functions carried out according to signals received by a light detection sensor integrated into the control panel according to certain embodiments; and

FIG. 13 shows a more detailed functional block diagram of the control system of FIG. 1 in accordance with a non-limiting example of implementation together with a functional block diagram of an external device.

In the drawings, the embodiments of the invention are illustrated by way of examples. It is to be expressly understood that the description and drawings are only for the purpose of illustration and are an aid for understanding. They are not intended to be a definition of the limits of the invention.

### DETAILED DESCRIPTION

The description below is directed to a specific implementation in the context of a bathing unit system. It is to be understood that the term “bathing unit system”, as used for the purposes of the present description, refers to bathing unit systems including spas, whirlpools, hot tubs, bathtubs, therapeutic baths, swimming pools and any other type of bathing unit that can be equipped with a controller and associated user control interface for controlling various operational settings of component in the bathing unit system.

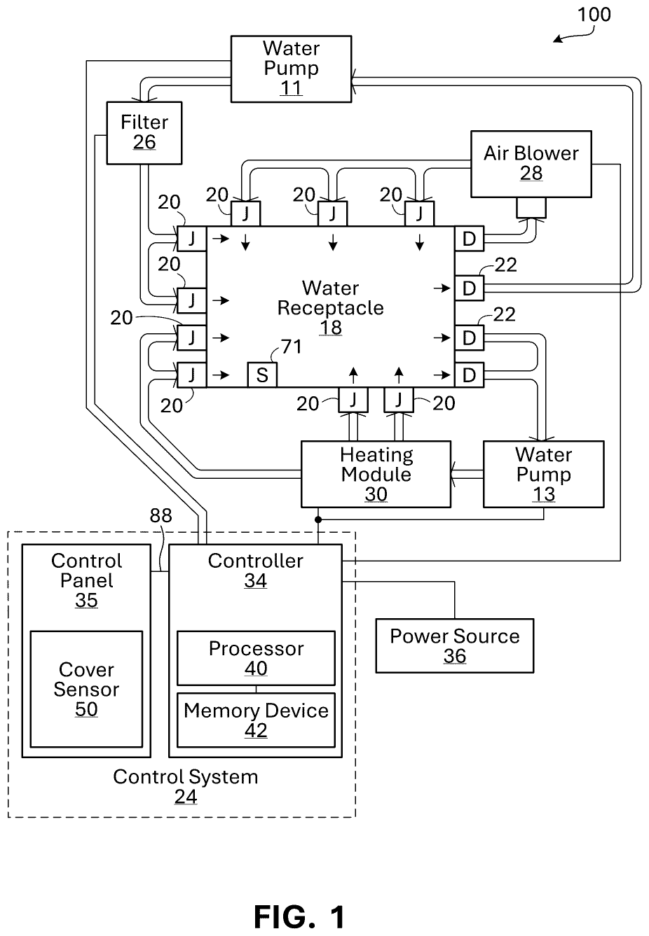

FIG. 1 illustrates a block diagram of a bathing unit system 100 equipped with a control system having a control panel 35. The bathing unit system 100 includes a water receptacle 18 for holding water, a set of drains 22 and a control system 24 comprised of a controller 34 and of the control panel 35. In the specific embodiment shown in FIG. 1, the bathing unit system 100 further includes a set of bathing unit components (also referred to hereinafter as “comfort components”) comprising a heating module 30, two water pumps 11 and 13, a plurality of jets 20, a filter 26 and one or more air blowers 28. It should be understood that, in alternate embodiments, the bathing unit system 100 could include more or less of the same or of different bathing unit components. For example, although not shown in FIG. 1, the bathing unit system 100 may include a sanitizer module, a water quality sensor, a lighting system for lighting up the water in the water receptacle 18, multimedia devices such as an MP3 player, a CD/DVD player as well as any other suitable device.

In normal operation, water flows from the bathing unit receptacle 18, through the drains 22 and is pumped by water pump 13 through the heating module 30 where the water is heated. The heated water then leaves the heating module 30 and re-enters the bathing unit receptacle 18 through jets 20. In addition, water flows from the bathing unit receptacle 18, through different drains 22 and is pumped by water pump 11 through filter 26. The filtered water then re-enters the bathing unit receptacle 18 through different jets 20. Water can flow through these two cycles continuously while the bathing unit system 100 is in operation. Optionally, water can also flow from the bathing unit receptacle 18 through one or more drains 22 to one or more air blowers 28 that are operative for delivering air bubbles to water that re-enters the bathing unit receptacle 18 through jets 20.

In the non-limiting embodiment shown, the control system 24 includes a controller 34 including circuitry for controlling the operational settings of the different components in the set of bathing unit components 11, 13, 26, 28, 30. In the embodiment depicted in FIG. 1, the circuitry for controlling the operational settings of the different components is shown as including a processing unit or processor 40 and a memory device 42 that are in communication with one another over a communication bus. The processor 40 may be configured for accessing and processing program instructions stored within the memory device 42 for enabling the controller 34 to control the set of bathing unit components 11, 13, 26, 28 and 30 at least in part on the basis of those program instructions and commands received from a user, for example via the control panel 35.

As depicted, the controller 34 receives electrical power from an electric power source 36 that is connected to the controller 34 via service wiring. The power source 36 supplies the controller 34 with any conventional power service suitable for residential or commercial use. The controller 34 may then controls the distribution of power supplied to the various bathing unit components 11, 13, 26, 28, 30 and to the control panel 35 in order to cause desired operational settings to be implemented.

In a non-limiting implementation, the power source 36 can supply 240 volts (V) AC to the controller 34 via service wiring. In an alternative non-limiting implementation, the power source 36 can supply 120 volts (V) AC to the controller 34 via service wiring. In yet a further alternative non-limiting implementation, the power source 36 can supply 120 Volts and 240 Volts AC to the controller 34 via service wiring. It is to be appreciated that other voltage supply values or voltage supply combinations, for example depending on geographical location, are possible. In a non-limiting implementation, the service wiring is passed through a ground fault circuit interrupter (GFCI) that is adapted for tripping in the presence of a current leakage to the ground. The ground fault circuit interrupter (GFCI) provides an added safety measure to the bathing unit system.

The controller 34 is in communication with the control panel 35 over communication link 88, which may be a wire line data bus or a wireless communication link for example, for receiving commands originating from a user input provided at the control panel 35. In some implementations, the controller 34 may also be configured for receiving commands from auxiliary devices (not shown in FIG. 1) external to the bathing unit system 100, for example via RF signals, infrared signals, or via a network communication (over an Intranet or the Internet) in accordance with any suitable method. One approach is described is U.S. Patent publication No. US20130166965 A1 entitled “Method and system for providing remote monitoring and control of a bathing system”. Other approaches are described in U.S. Pat. No. 8,644,960 entitled “Method and system for providing ambiance settings in a bathing system.” The contents of the aforementioned documents are incorporated herein by reference. These and various other approaches and systems for remotely controlling bathing unit systems are known in the art and will thus not be described further here.

As mentioned above, the bathing unit system 100 is equipped with a control panel 35. The control panel 35 provides an interface for allowing a user of the bathing unit system 100 to provide commands or other information to the controller 34 of the control system 24. In specific practical implementations, via the control panel 35, a user may be able to enter commands that can be implemented by the controller 34 for controlling the activation and operational settings of the various bathing unit components and for monitoring the operational status of the bathing unit components as well as for monitoring operational characteristics of the bathing unit system, such as water temperature, ambient temperature and/or water quality for example.

In particular, the control panel 35 may send signals to the bathing unit controller 34 over a communication link 88 for controlling operational setting of bathing unit components in the bathing unit system 100. Similarly, the control panel 35 may receive over communication link 88 incoming signals from the bathing unit controller 34, which can include signals conveying operational settings of the bathing unit system 100 and well as various metrics obtained through sensors (e.g. water temperature sensor 71, ambient temperature sensor, water quality metrics sensors etc.). In some implementations, the control panel 35 may also receive from the bathing unit controller 34 data conveying user identification information associated with a user of the bathing unit system. As such, via the control panel 35, a user can enter commands that can be implemented by the controller 34 for controlling the activation and operational settings of the various bathing unit components.

In specific practical implementations, the control panel 35 provides a user operable interface including one or more user operable input devices that allow a user to enter commands for causing the controller 34 to control various operational settings of the bathing unit components 11, 13, 26, 28, 30. Some non-limiting examples of operational settings include temperature control settings, jet control settings, and lighting settings, among other possibilities. In a non-limiting embodiment where the bathing unit is connected to entertainment and/or multimedia modules, the operational settings of the bathing unit may also include audio settings and video settings, amongst others. Consequently, the expression “operational settings”, for the purpose of the present disclosure, is intended to cover operational settings for any suitable bathing unit component or components that can be operated by a user of the bathing unit system 100.

The control panel 35 may further provide a menu-driven interface through which a user can navigate and be presented with a set of selectable ambiance options, wherein each ambiance option is associated with a respective set of operational setting for different bathing unit components, each set corresponding to a respective desired total effect (or ambiance) for the bathing unit system. Upon selection of one of the presented options, the bathing unit system is caused to apply corresponding operational settings to different bathing unit components in the system in order to achieve a corresponding desired total effect (or ambiance). An example of such functionality is described in U.S. Pat. No. 8,644,960 entitled “Method and system for providing ambiance settings in a bathing system”.

As will become apparent from the present description, in the context of a bathing unit system 100 have a controller with light detection sensors, the control panel 35 aims to provide functionality for allowing automatic changes to the bathing unit system including to the control panel 35 itself.

The bathing unit system includes a light detection sensor 50 that detects when the bathing unit cover is off. As such, when the control system 24 can detect that a cover for the water receptacle 18 is on or off.

For the purpose of simplicity and conciseness, while the control panel 35 may provide many different functions, the description from hereon will focus on the functionality and components pertaining to reading of the light detection sensor to control operational settings for one or more different specific bathing unit components, in particular by way of inputs provided at the control panel 35. It is to be understood that such functionality may be provided instead of, or in combination with, other functionality in the control panel 35 through suitable software and hardware components as will become readily apparent from the person skilled in the art in view of the description.

### Control Panel

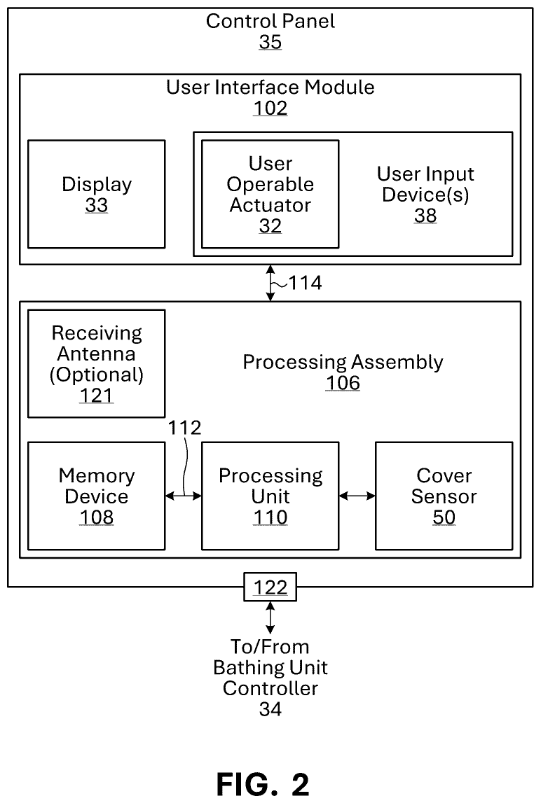

FIG. 2 shows a functional block diagram of the control panel 35 of the bathing unit system 100. The control panel 35 is a topside control panel, e.g., the control panel 35 is located on the upper surface of the wall or shell of the water receptacle 18. The control panel 35 is positioned so that when a spa cover is extended over the water and the spa cover is secured to the wall of the water receptacle 18, the control panel 35 is covered by the spa cover.

As depicted, the control panel 35 includes a user interface module 102 and a processing assembly 106 in communication with one another over communication link 114. The control panel 35 may also include one or more communications interfaces for receiving or sending data to external electronic devices. In the embodiment depicted in FIG. 2, the control panel 35 includes a communication interface 122 for allowing the control panel 35 to communicate with the controller 34 (shown in FIG. 1) by sending and/or receiving signals to/from the controller 34 over communication link 88. In specific practical implementations, the communication interface 122 may be a wired interface so that the communication between the control panel 35 and the controller 34 is made over a wire-line link. Alternatively, the communication interface 122 may be a wireless interface so that the communication between the control panel 35 and the controller 34 is made over a wireless link, such as a RF link for example. Additional communication interfaces may also be provided at the control panel 35 in alternative embodiments.

### User Interface Module

The user interface module 102 provides components for enabling interactions with a user of the bathing unit system 100, including receiving information from and conveying information to the user. In the embodiment depicted, the user interface module 102 comprises one or more user input devices 38 and a display screen 33. The display screen 33 is operative for receiving and processing display command signals from the processing assembly 106 for displaying a graphical user interface (GUI) to a user. The GUI may provide the user with information pertaining to the bathing unit system 100, which may include for example water temperature and operational status of various components for example. The GUI enables the user to view various selectable control options as well as allow the user to provide input commands for controlling various bathing unit components of the bathing unit system through the one or more user input devices 38. In this regard, the GUI may implement a plurality of different display windows through which a user can navigate using the one or more user input device 38 to access desired information and provide desired inputs for adjusting and activating operational settings of the bathing unit components.

The user interface module 102 includes a user operable actuator 32. The nature of the user operable actuator 32, and therefore the nature of the type of user input performed by the user at the control panel 35, may differ in different implementations. For example, the user operable actuator 32 may be in the form of a tactile zone on the display screen 33, a mechanically operated actuator (such as a switch or a push-button or rotary dial for example) and/or any other suitable user operable actuator allowing a user to provide a user input. In specific practical implementations, the user operable actuator 32 may comprise a trackball, mouse, a keypad, a touch sensitive screen, turn-dials, turn-and-push dials (such as iDrive™ from BMW®), a stylus pen or a microphone, among other possibilities. The user operable actuator 32 may also include one or a combination of any or all of the above input devices.

In a specific non-limiting implementation, the user operable actuator 32 may be in the form of a tactile zone on the display screen 33 of the control panel 35 and may optionally be configured for providing haptic feedback. In another specific non-limiting implementation, the user operable actuator 32 may be in the form of a mechanically operated actuator (such a push-button or key for example) and the selected action may therefore be a manual actuation of the user operable actuator 32 through a push-button like action for example. Many other examples of implementation are possible and will become apparent to the person skilled in the art.

### Processing Assembly

As mentioned above, the user interface module 102 is in communication with the processing assembly 106 over communication link 114. The processing assembly 106 includes suitable hardware, firmware and/or executable software code for implementing various functions for the control panel 35.

In the embodiment depicted in FIG. 2, the processing assembly 106 includes a memory device 108 and a processing unit 110 in communication with one another over a communication bus 112. The memory device 108 stores program instructions executable by the processing unit 110 as well as data and may be comprised of a single memory unit or of a plurality of memory units. When the memory device 108 is comprised of a plurality of memory units, the memory units may be of a same type or of different types.

The processing assembly 106 includes the light detection sensor 50. The light detection sensor 50 is embodied as a light sensor. The light sensor can detect the presence and/or intensity of the ambient light, e.g., light from the environment that impinges on the light detection sensor 50. In some embodiments, the light detection sensor 50 can detect the presence and/or intensity of light emitted by a light emitter when the light emitter and the light sensor are in contact with each other or close to each other. The light detection sensor 50 can be configured to measure at least one of visible light and infrared light. In any case, the light detection sensor 50 is configured to measure lighting conditions incident on the control panel 35. Communication between the processing unit 110 and the light detection sensor 50 can be wireless and/or wired. The light detection sensor 50 can provide an indication that the spa cover is closed and attached to the wall of the water receptacle 18 when the light detection sensor 50 does not detect light (e.g., when the light detection sensor abuts a surface of the spa cover and thereby does not permit any light to impinge on the light detection sensor 50). That is, in the closed position the spa cover concurrently covers the water receptacle 18 and a top portion of the peripheral wall 140 of the water receptacle 18. The light detection sensor 50 can provide an indication that the spa cover is not closed when the light detection sensor 50 detects light.

The memory device 108 may store mapping information mapping each of a set of operating conditions to a corresponding subset of bathing unit components from the plurality of bathing unit components in the bathing unit system. In a first specific example, in response to the light detection sensor 50 indicating that the spa cover is off, the control panel 35 may enable the user to achieve desired settings at least in part by adapting the GUI to present the user with a control menu providing user operable inputs for providing specific operational settings for bathing unit components in the corresponding specific subset of bathing unit components. If the light detection sensor 50 indicates that the spa cover in on, the control panel 35 may modify the user input devices, by e.g., reducing or disabling at least part of the user interface. For example, the tactile zone on the display screen 33 of the control panel 35 so that user input devices or less prone to, or non-responsive to, user input.

The memory device 108 may also store a set of ambiance settings including one or more ambiance settings, where each ambiance setting is associated with a corresponding set of operational settings for bathing unit components in the bathing unit system 100 to obtain a desired total effect (or ambiance) for the bathing unit system 100. Information conveying different ambiance settings may be stored in the memory device 108 and may be pre-programmed, for example at the time of manufacturing of the control panel 35 or through a user or manufacturer-initiated software update process. Alternatively, or in addition to the above, one or more of the ambiance settings stored in memory device 108 may be programmed by a user through the user interface module 102 or via another suitably programmed remote user computing device. Ambiances may be programmed through the user interface module 102 or via another suitably programmed remote user computing device in any suitable manner known in the art. For example, methods of the type described in U.S. Pat. No. 8,644,960 entitled “Method and system for providing ambiance settings in a bathing system,” may be used to create and store new ambiances in the memory device 108. Alternatively, some or all the operational settings associated with one or more of the ambiance settings may be stored on a memory device external to memory device 108, such as for example on a portable memory device or, alternatively, in the memory device 42 of the controller 34 (shown in FIG. 1) and be electronically accessible via the control panel 35.

In practical implementations, the set of ambient settings may include at least one ambiance setting associated with different types of bathing unit components; for example, heating module 30, water pumps 11 and 13, air blower 28, lighting units (not shown), audio system (not shown), and the like. It should be appreciated that one or more bathing unit components may be associated to each type of bathing unit component, and the control panel 35 may be configured to include pre-programmed operational settings for the multiple bathing unit components of a given type of bathing unit component.

The ambiance settings may include pre-programmed component activation status, for example, for a given ambiance setting, the ambiance setting would cause activation of water pumps 11 and 13, but deactivation of air blower 28. In other words, the pre-programmed ambiance settings may cause activation of operational settings associated with different types of bathing unit components, such as variable speed water pumps for water jets, the lighting units, the audio system, the heating module, the sanitization system, and the like. Furthermore, an ambiance setting instead of causing the activation of a single speed for a pump, may cause the activation of a pre-programmed massage function for each variable speed pump that provides a sequence of different speeds according to a pre-defined massage profile.

As for the light, the ambiance setting may cause the activation of a desired color, a desired light intensity, or pre-programmed color sequences to create some ambiance effect.

Examples of pre-programmed ambiance settings may thus include pre-set ambiance settings such as a “relaxation setting”, a “beach party” setting, an “after work” setting, or ambiance settings associated with user identification information, such as “Jen's setting”, “Ben's setting” and/or identification information associated with a personal electronic device belonging to a specific person (for example a media access control addresses (MAC address) of a smartphone, smart watch, personal wearable electronic activity tracker and the like), or ambiance settings associated with a previously used setting such as “last used setting” and/or or ambiance settings associated with specific timing information (such as time of day, day of the week and/or time of the year or season, or cost of energy for example). Each setting may be associated with a respective set of operational settings for a set of bathing unit components.

The ambiance settings may be programmed by a manufacturer of the bathing unit system 100 or by an individual user. For example, the manufacturer of the bathing unit system 100 may pre-program a plurality of different ambiance settings into the memory device 108. It is also possible for a user of the bathing unit system 100 to program one or more different ambiance settings into the memory device 108 through the user interface module 102.

The processing unit 110, which may include one or more processors, is in communication with the memory device 108 and is configured for accessing and processing program instructions and data stored within the memory device 108. The program instructions stored in the memory device 108, when executed by the processing unit 110, may implement at least some functions of the control panel 35 including, for example but without being limited to, the processing of signals originating from the user interface module 102. For example, the processing unit 110 may process a signal generated as a result of actuation of one or more of the user input devices 38 in order to generate signals to either cause display signals to be sent to the display screen 33 in order to display a specific GUI and/or to generate suitable control commands to be sent to the bathing unit controller 34 in order to control operational settings of components in the bathing unit system in a specific manner. For example, the program instructions stored in the memory device 108 may implement a menu driven interface through which a user can navigate by actuating the user input devices 38 and be presented on the display device with a set of selectable options. As another example, the processing unit 110 may process signals originating from the bathing unit controller 34 to derive display signals to be sent to the display screen 33 to display a specific GUI. For example, the signals originating from the bathing unit controller 34 may convey status information and/or notifications pertaining to the operational status one or more of the bathing unit components in the bathing unit system 100 and/or information obtained from sensors in the bathing unit system (e.g. water temperature, ambient temperature, water quality and the like).

In some practical implementations, the control panel 35 may be configured to adapt the GUI and/or to adapt the control of spa components in the bathing unit system based on user identification information. In such implementations, information associated with the user identity may be received at the control panel 35 via a user identification signal, which may originate from an auxiliary device external to the bathing unit system. In specific non-limiting implementations of a first type, the user identification signal may be transmitted over a wireless communication link, such as for example a radio frequency (RF) link, directly to the control panel 35. In such implementation, the control panel may include a receiving antenna 121 (shown in FIG. 2) configured for establishing a communication link with the auxiliary device. The auxiliary device may be any suitable device capable of communicating information conveying user identity information such as, for example but without being limited to, a smartphone, a smartwatch, a wearable electronic activity tracker (such as a fitness band) and/or a near-field communication (NFC) or RFID enabled device. As mentioned above, in a specific practical example of implementation, the auxiliary device may be in the form of an RFID or NFC chip implanted in a portion of a user's body (for example in a user's hand, arm, leg or other suitable body part). Any suitable communication protocol and associated software/hardware component may be provided to allow the control panel 35 communication with the auxiliary device. In a non-limiting example of implementation, a protocol suitable for short range communication, such as Bluetooth for example, may be used.

While the receiving antenna 121 for receiving user identification information has been shown in FIG. 2 as being a component of the control panel 35, it is to be appreciated that such a device may be positioned elsewhere in the bathing unit system 100. For example, rather than being transmitted to the control panel 35 directly from the auxiliary device, the user identification signal may be transmitted over a wireless communication link to the control panel 35 through one or more other component of the bathing unit system 100, such as for example through the controller 34 of the bathing unit, via sensors (not shown), and/or through an audio/visual component of the system. In implementations of this alternate type, the controller 34, the sensors, the audio/visual component (not shown) and/or other component of the bathing unit system 100 (shown in FIG. 1) may be equipped with hardware and software components suitable to allow establishing a wireless communication link with the auxiliary device (to receive the user identification signal) and to establish another communication link with the control panel 35 over which data conveying the user identity may be transmitted. Advantageously, in such an embodiment, the information received from the specific sensor at the control panel 35 provides the control panel with an indicator information conveying the status of the spa cover. Other variants of implementation are possible and will become apparent to the person skilled in the art in view of the present description.

### Practical Examples of Implementations of the Control Panel

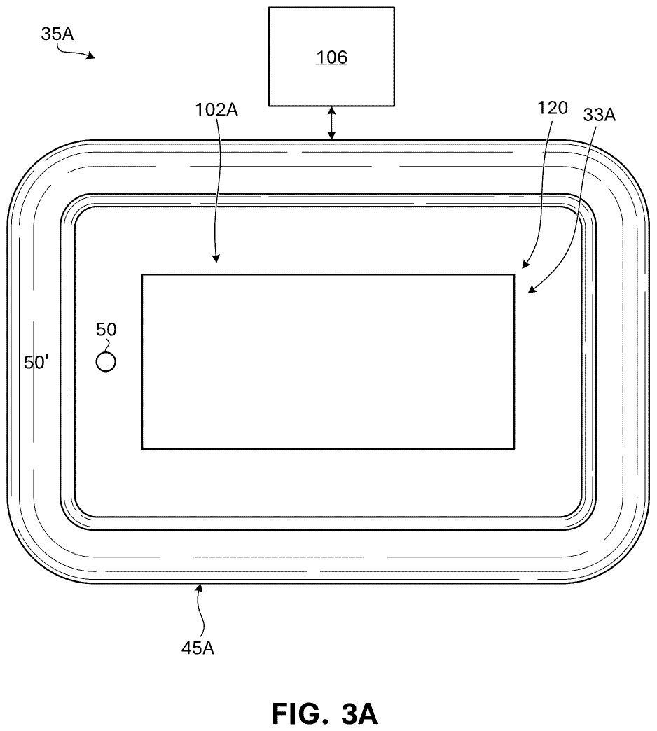

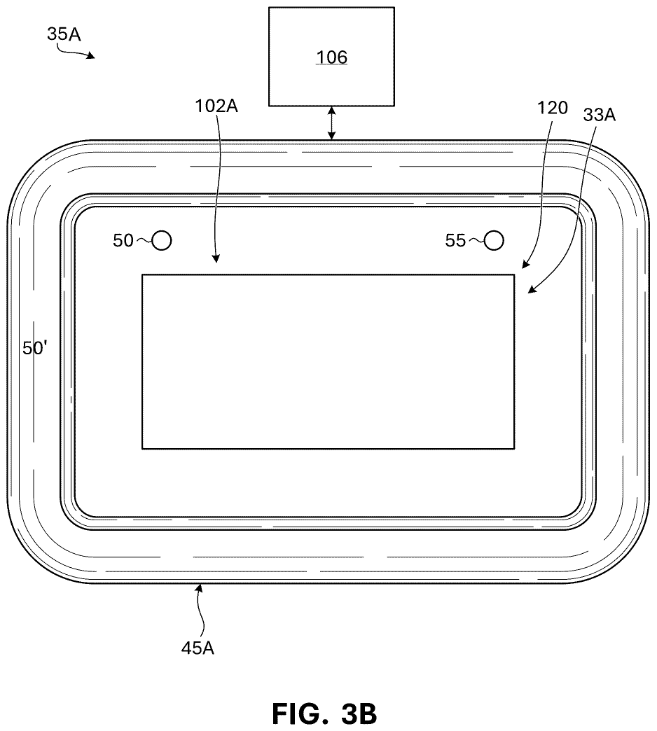

The control panel 35 described with reference to FIG. 2 may be embodied in many different manners in practice. A specific example of implementation will now be described with reference to FIG. 3A. It is to be understood that this example is merely presented to illustrate manners in which some of the concepts described above may be implemented in practical embodiments. Other embodiments will become apparent to the person skilled in the art in light of the present description.

FIG. 3A shows a specific implementation of a control panel 35A, analogous to the control panel 35 shown in FIG. 2. The control panel 35A is in the form of a topside control panel and includes a panel body or housing 45A upon which is positioned the user interface module 102A that includes a display touch or presence-sensitive assembly 120, the touch or presence-sensitive assembly 120 including one or more tactile zones for associating user tactile input to software-implemented actions. The touch or presence-sensitive assembly 120 may be in the form of an LCD/touch screen display device. The control panel 35A also includes the processing assembly 106 that includes a circuit board electrically coupled to the touch or presence-sensitive assembly 120. The processing assembly 106 includes a memory device, analogous to memory device 108 (shown in FIG. 2) and a processing unit, analogous to processing unit 110 (also shown in FIG. 2). The memory device may store data relating to operational conditions of the plurality of bathing unit components and program instructions for allowing the control panel 35A to implement various functions.

In the embodiment shown, the display touch or presence-sensitive assembly 120 includes a touch sensitive display screen portion 33A, analogous to the display screen 33 (shown in FIG. 2), and a user operable actuator in the form of a tactile zones on the touch sensitive display screen portion 33A, analogous to user operable actuator 32 (shown in FIG. 2). In a practical implementation, the touch sensitive display screen portion 33A may use capacitive sensor technology, in which case it can sense changes in capacitance at areas of the display screen portion 33A caused by nearness of a user's finger or other object (such as a stylus) to the touch sensitive layer. The control panel 35A may therefore be touch or presence-sensitive to the user's finger or other device such as a stylus. The sensitivity of the display screen portion 33A may typically be adjusted, e.g., through software driver adjustment, so that the user may not need to even physically touch the cover layer to actuate a button or some other activity such as a swipe. The touch sensitive display screen portion 33A is responsive to changes in capacitance resulting from touching or close proximity of an object to the touch or presence-sensitive layer to generate and transmit signals to the processor in the processing unit 110. In a practical implementation, the LCD/touch screen display assembly 33A is a TFT LCD (thin film transistor liquid crystal display) module. Displays employing other known technologies may be used in alternate implementations and thus need not be described in greater detail here.

In specific practical implementations, the tactile zones may provide haptic feedback when operated by a user in a push-button like action. In some alternative embodiments, one or more of the tactile zones may be embodied in one or more mechanical actuators positioned beside the display touch or presence-sensitive assembly 120 which may be actuated when operated by a user in a push-button like action. Many other variants for implementing the tactile zone are possible and will become apparent to the person skilled in the art in view of the present description.

In some embodiments, the program instructions stored in the memory device may cause the processor of the circuit board assembly to generate a display signal for causing the display screen portion 33A to display information conveying selected settings in response to a user input provided by the user via the control panel.

In some embodiments, the light detection sensor 50 is integrated in the control panel 35A. The light detection sensor 50 is located within or on the housing 45A and is proximate the user interface module 102A. In FIG. 3A, the light detection sensor 50 is shown to the left of the touch or presence-sensitive assembly 120, on the upper surface of the housing 45A. However, the light detection sensor can be positioned to the right, above, or below the touch or presence-sensitive assembly 120. In some embodiments, the light detection sensor 50 can be on the side of the control panel 35A. Rather than being on the upper surface, the light detection sensor 50 can be located on the side of the housing 45A proximate the user interface module 102A, for example at location 50′, or to the right, above, or below the user interface module 102A.

FIG. 3B also shows an implementation similar to that of FIG. 3A, where the light detection sensor 50 and additionally a second light detection sensor 55 are integrated in the control panel 35A. The two light detection sensors 50, 55 are located within or on the housing 45A and are spaced apart from each other, e.g., at opposite sides of the touch or presence-sensitive assembly 120. The two light detection sensors 50, 55 are in proximity to the user interface module 102A. In FIG. 3B, the two light detection sensors 50, 55 are shown above the user interface module 102A, on the upper surface of the housing 45A. However the two light detection sensors 50, 55 can be positioned to the right, left, and/or below the user interface module 102A. Two light detection sensors 50, 55 are shown, but three or more light detection sensors are also possible. In some embodiments, one or both of the light detection sensors 50, 55 can be on the side of the control panel 35A. Rather than being on the upper surface, the light detection sensor 50 and/or the light detection sensor 55 can be located on the side of the housing 45A, for example at location 50′, or to the right, above, or below the user interface module 102A.

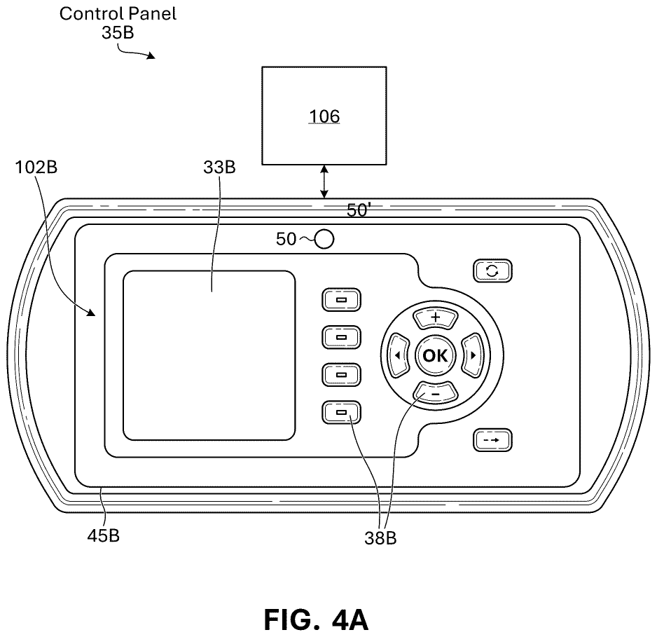

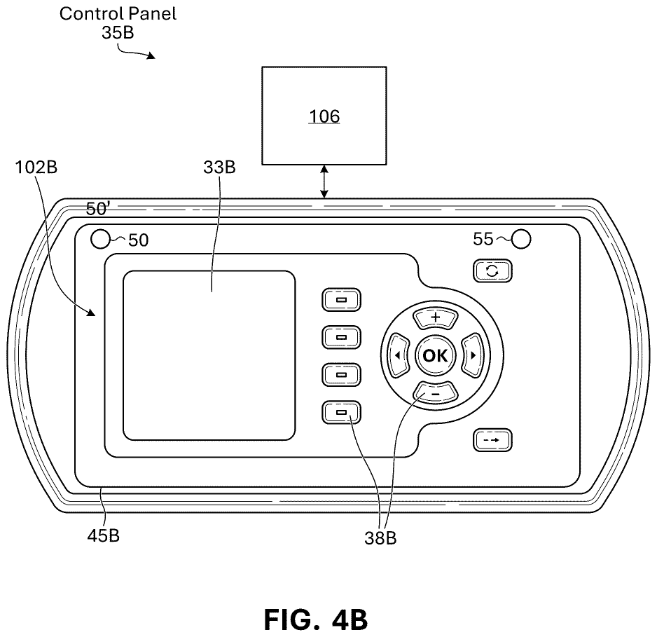

FIG. 4A shows a specific second implementation of a control panel 35B, analogous to the control panel 35 shown in FIG. 2. The control panel 35B comprises a display screen 33B and a user input device 38B, which in the embodiment shown, comprises a plurality of buttons that can be pressed by a user to scroll through and select options offered by the graphical user interface displayed on the display screen 33B. Although the user input devices 38B shown in FIG. 4A comprises a plurality of push buttons, it should be appreciated that any other type, or combination, of user input devices known in the art could be used, including a pointing device, trackball, mouse, gyroscope remote (which senses movement of the device in the air so as to move a cursor), a keypad, a touch sensitive screen, turn-dials, turn-and-push dials, a stylus pen or a microphone, among other possibilities. In addition, more than one type of user input device may be provided on the control panel.

The control panel 35B also includes a processing assembly 106 that includes a circuit board electrically coupled to the user input device 38B and display screen 33B of the user interface module 102B. The processing assembly 106 includes a memory device, analogous to memory device 108 (shown in FIG. 2) and a processing unit, analogous to processing unit 110 (also shown in FIG. 2). The memory device may store data relating to operational conditions of the plurality of bathing unit components and program instructions for allowing the control panel 35B to implement various functions.

FIG. 4B also shows an implementation where the light detection sensor 50 as well as a second light detection sensor 55 are integrated in a control panel 35B. The two light detection sensors 50, 55 are located within the housing 45B and are spaced apart from each other. The two light detection sensors 50, 55 are in proximity to the user interface module 102B. In FIG. 4B, the two light detection sensors 50, 55 are shown above the user interface module 102B, however the two light detection sensors 50, 55 can be positioned to the right, left, and/or below the user interface module 102B. Two light detection sensors 50, 55 are shown, but three or more light detection sensors are also possible. In some embodiments, one or both of the light detection sensors 50, 55 can be on the side of the control panel 35B. Rather than being on the upper surface, the light detection sensor 50 and/or the light detection sensor 55 can be located on the side of the housing 45B, for example at location 50′, or to the right, above, or below the user interface module 102B.

### Installation in a Bathing Unit System

As mentioned above, the control panel 35 (or control panels 35A, or control panels 35B) described above is for use in connection with bathing unit systems having a cover to facilitate the control of such systems. Such bathing unit systems can include spas having spa tubs, although it will be appreciated that the subject matter may be practiced in connection with other suitable bathing unit systems. The user control interface that is in the control panel 35 is suitable to be located on the topside of a bathing unit receptacle so that it can be accessed by a user bathing in the water receptacle 18.

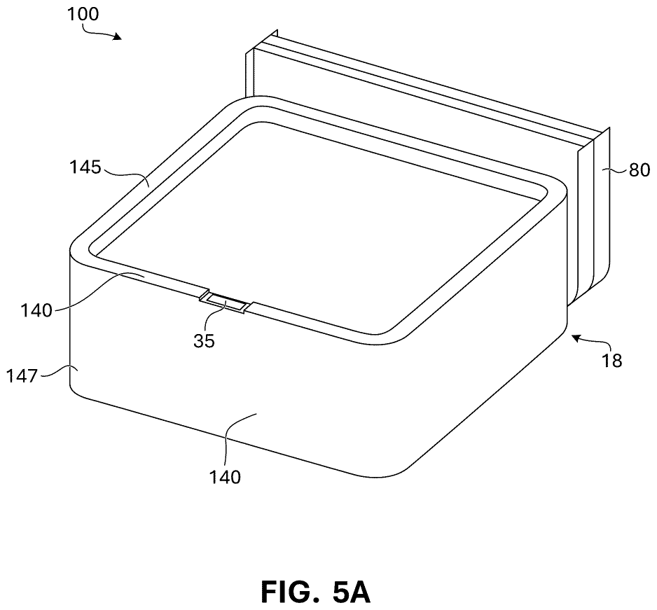

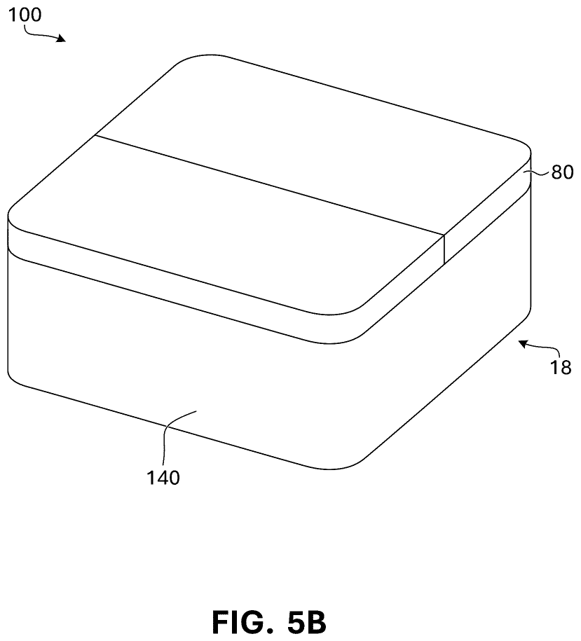

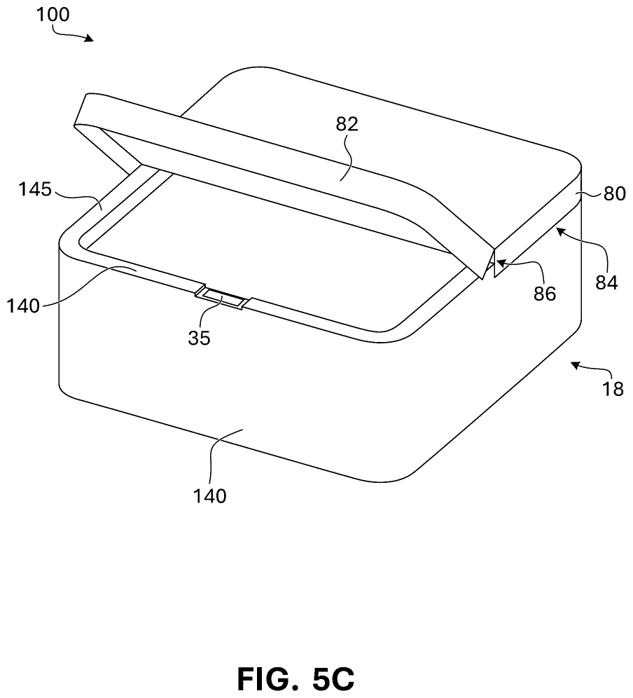

FIG. 5A shows a typical installation in which the control panel 35 is mounted to a surface of the bathing unit system. As shown, the bathing unit system 100 includes a water receptacle 18 for holding water. The water receptacle 18 has a peripheral wall 140 formed of a one or more panels 147 that form an upper surface 145. While not shown, the bathing unit system 100 of FIG. 5A also includes a plurality of bathing unit components including at least a circulation pump and a heater as described above. The bathing unit system 100 also includes a controller (not shown), of the type described with reference to controller 34 shown in FIG. 1, in communication with the control panel 35 for controlling operational settings associated with the bathing unit components in accordance with the principles described earlier in the present document. The control panel 35 is a topside control panel and is positioned on an upper surface 145 of the peripheral wall 140 of the water receptacle 18 so that the upper surface 145 includes the display screen 33.

Also shown in FIG. 5A is a spa cover 80 that is shown in a retracted or open position. FIG. 5B shows the spa cover 80 in a deployed or closed configuration where it spans the water within the water receptacle 18 and fits around the peripheral wall 140. As can be seen, when the spa cover 80 is deployed, the control panel 35 including the light detection sensor 50 is covered. The spa cover 80 can be any type of spa cover as is known in the art, and here is depicted as a single-fold two-panel cover.

The light detection sensor 50 can be configured to detect one or more states of the bathing unit system 100 including at least a first state and a second state. The first state can be an open state in which the spa cover 80 is not covering the upper surface 145 of the peripheral wall 140, as shown in FIG. 5A. The second state can be a closed state in which the spa cover 80 is covering the upper surface 145 of the peripheral wall 140, as is shown in FIG. 5B. The light detection sensor 50 can also be configured to detect a third state of the bathing unit system 100, such as a partially open state shown in FIG. 5C.

The light detection sensor 50 can detect the first state of the bathing unit system 100 when, for example, light is able to fall on the light detection sensor 50, as in FIG. 5A. That is, the light detection sensor 50 can detect that the light falling on the light detection sensor 50 is higher than a certain threshold, indicating that the light detection sensor is uncovered and able to detect the ambient light. On the other hand, the light detection sensor 50 can detect the second state of the bathing unit system 100 when little or no light falls on the light detection sensor 50, e.g., when the spa cover 80 covers the control panel, as in FIG. 5B. That is, the light detection sensor 50 can detect that the light falling on the light detection sensor 50 is lower than a certain threshold, indicating that the light detection sensor is covered and unable to detect any ambient light.

A third state can be an intermediate, partially open state between the open state of FIG. 5A and the closed state of FIG. 5B. In the third state, shown in FIG. 5C. The spa cover 80 has a first cover panel 82 that is retracted from covering a first portion of the water receptacle 18 while a second cover panel 84 is covering a second portion of the water receptacle 18. The first cover panel 82 and the second cover panel 84 are connected at a hinge 86.

### Other Installation Embodiments

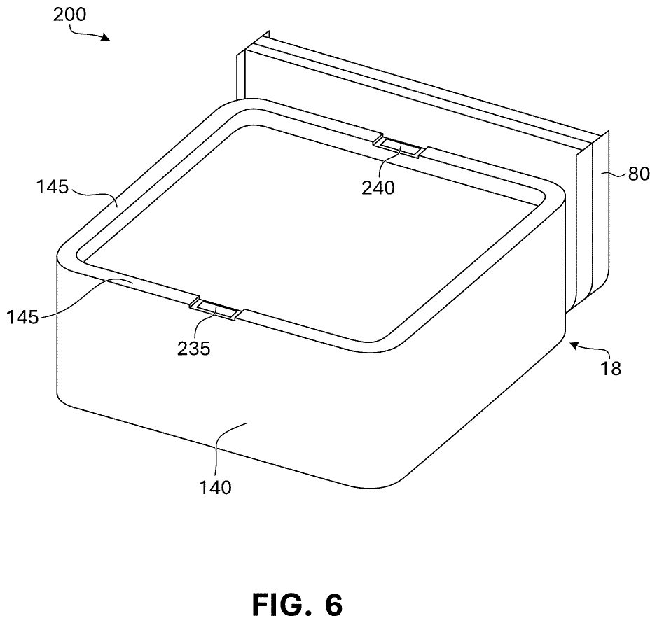

FIG. 6 shows another embodiment of a bathing unit system 200. The bathing unit system 200 is analogous to the bathing unit system of FIGS. 5A to 5C. However, the bathing unit system 200 has a first control panel 235 and a second control panel 240. The first control panel 235 and the second control panel 240 are positioned at different locations on the upper surface 145 of the peripheral wall 140, such as opposite to each other across the water receptacle 18. Two control panels with integrated light detection sensors allow detection of the spa cover 80 being partially-opened (e.g., as shown in FIG. 5C). In some embodiments, the second control panel 240 is largely identical to the first control panel 235. In some embodiments, the second control panel 240 does not include most of the components of the first control panel 235, having only a light detection sensor 50. The controller of the first control panel 235 can receive signals from the second control panel 240 that comprises a second light detection sensor 50.

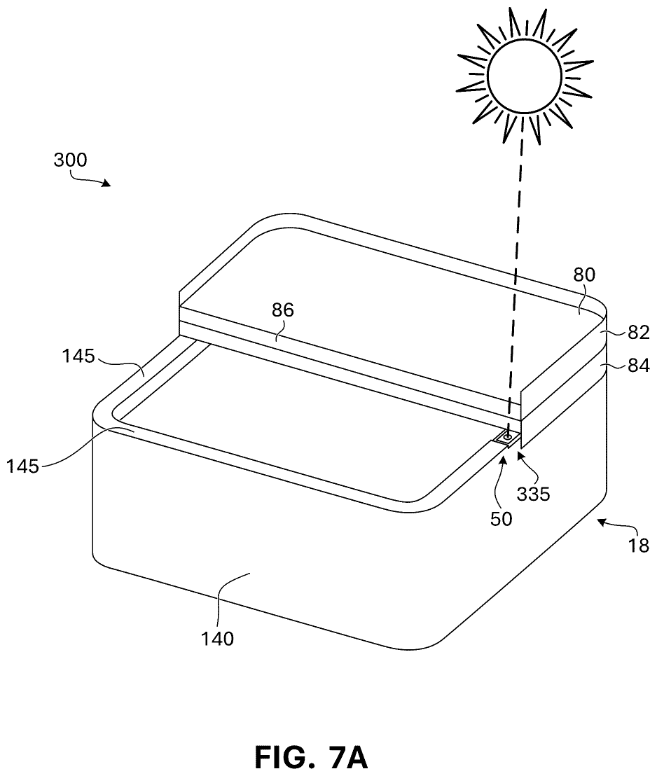

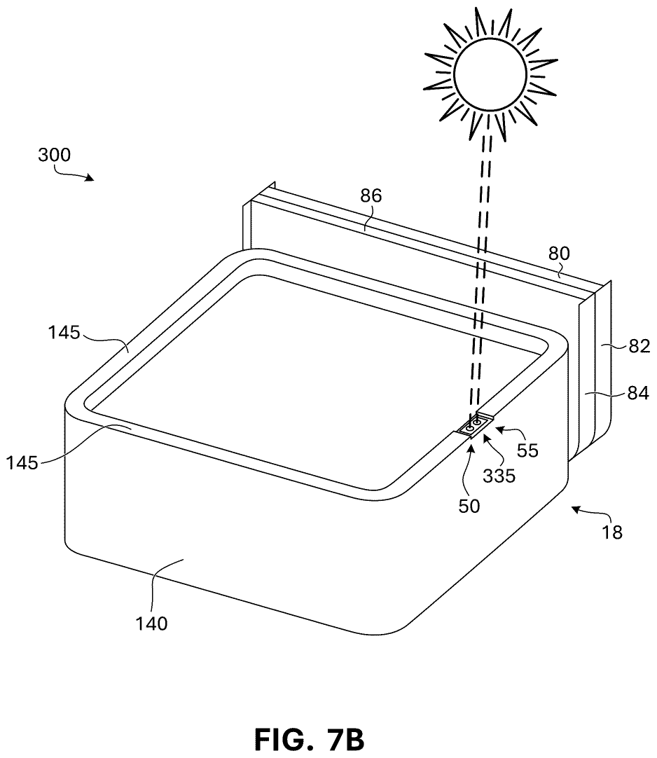

FIGS. 7A and 7B show yet another embodiment of a bathing unit system 300. The bathing unit system 300 is analogous to the bathing unit system of FIGS. 5A to 5C. There is a single control panel 335 (as in the bathing unit system 100 of FIGS. 5A to 5C). The control panel 335 has two light detection sensors 50, 55 integrated into the control panel, akin to the control panels shown in FIG. 3B and FIG. 4B.

The control panel 335 is configured to be positioned at a location on the upper surface 145 of the peripheral wall 140 so that when the spa cover 80 is closed it stretches over and covers the control panel 335 and selectively covers and uncovers each of the two light detection sensors 50, 55. That is, the control panel 335 can be only partially, rather than fully, covered by the spa cover 80.

FIG. 7A shows the spa cover 80 in a partially open configuration, with the second cover panel 84 covering a portion of the water receptacle 18 while the first cover panel 82 is retracted and does not cover the remainder of the water receptacle 18. The control panel 335 is positioned on the upper surface 145 so as to be overlaid by the hinge 86 that connects the first cover panel 82 and the second cover panel 84. In the partially open configuration, the control panel 335 is partially uncovered by the retracted first cover panel 82 and light can fall on the light detection sensor 50. The second cover panel 84 covers the second light detection sensor 55 (shown in FIG. 7B) and does not permit light to impinge on the second light detection sensor 55.

In FIG. 7B the second cover panel 84 has also been removed from spanning over the water receptacle 18, thereby uncovering the second light detection sensor 55.

FIGS. 7A and 7B illustrate an embodiment where the control panel 335 has two light detection sensors 50, 55 that permit the system to determine that the bathing unit system is in a partially-open state. However, other methods of determining a partially-open state using a single light detection sensor are also possible.

For example, a bathing unit with a single sensor can be provided (as in FIGS. 5A-5C). A calibration mode can be implemented to determine the different light levels that correspond to different spa cover configurations. First, the user can be directed to open spa cover 80 completely (as in FIG. 5A) and the controller 34 of the control panel 35 records the resulting signal (e.g., the signal strength) received by the light detection sensor 50. Then the user can be directed to close the spa cover 80 completely (as in FIG. 5B) and the controller 34 of the control panel 35 records the resulting signal received by the light detection sensor 50. The user can finally be directed to open spa cover 80 partially (as in FIG. 5C) and the controller 34 of the control panel 35 records the resulting signal (e.g., the signal strength) received by the light detection sensor 50. A comparison of the signal sent by the light detection sensor 50 at any subsequent time can be compared to these saved calibration values and a determination made as to the cover status.

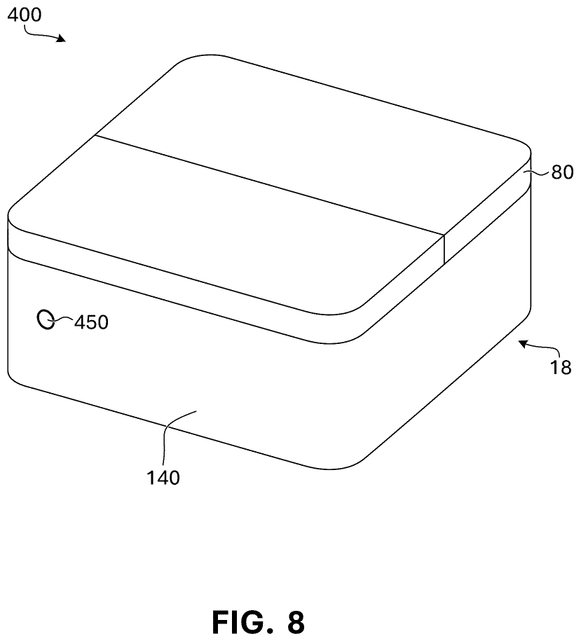

FIG. 8 shows a further embodiment of a bathing unit system 400. The bathing unit system 400 is analogous to any of bathing unit systems 100, 200, 300 described above. The bathing unit system 400 additionally includes an ambient light sensor 450. The ambient light sensor 450 can be positioned at any point on the outside of the peripheral wall 140 so that is spaced apart from the control panel. When the spa cover 80 is in any of the closed, open, or partially-open state the ambient light sensor 450 remains uncovered. The ambient light sensor 450 detects a brightness or luminosity of the ambient light surrounding the bathing unit system 400 and is in communication with the control panel 35 (or any of control panels described above).

In typical installations, the peripheral wall 140 of the water receptacle 18 may be fabricated in part using a moldable material, such as fiberglass or other materials, including metal and ceramic materials for example. In a practical implementation, the control panel 35 may be installed is a pre-made mount opening formed on the peripheral wall 140 or by drilling or otherwise forming such an opening in the bathing unit receptacle peripheral wall. The control panel 35 is installed so that wiring is passed through the mount opening to that it can be suitably connected to the controller. The topside control panel may further be secured in place upon the peripheral wall 140 using any suitable mounting fasteners and/or adhesives and/or mounting gaskets.

### Functionality Related to Light Detection Sensor(s)

### Select Operational Setting Based on Cover Status

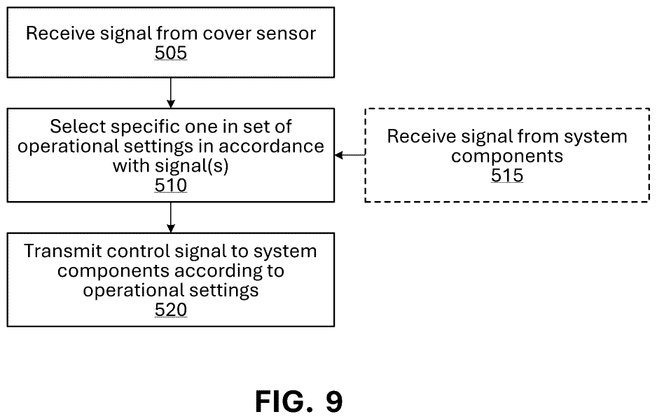

FIG. 9 illustrates possible functions carried out by any of the bathing unit systems 100, 200, 300, 400 described herein. At step 505, the system (e.g., the controller 34) receives a signal from the light detection sensor 50 that allows the system to determine if the bathing unit system is in an open cover state or closed cover state. This determination can be made, for example, by comparing a strength of the light signal received at the light detection sensor 50 to a threshold value. In some embodiments, the threshold value can be varied according to an ambient light sensor 450 if one is present in the system.

Once the controller 34 determines the state of the bathing unit system, the controller can communicate with a memory device such as memory device 42 (and/or the memory device 108). The memory device 42 can store multiple operational settings and operational processes used to operate the various components of the bathing unit system 100 according to the bathing unit system being in a cover-open or cover-closed state. The memory device 42 can also store operational settings used to operate the various components of the bathing unit system 100 according to the bathing unit system being in a partially opened state.

At step 515, in some embodiments the controller 34 can receive signals from other system components. These component signals can include an identity of the user, the time of day and/or time of year, operational status of the various system components, input from other sensors (e.g., temperature sensors).

At step 510, the controller 34 selects a specific one in the set of appropriate operational settings according to the light detection sensor signal. Selection of the specific operational setting can additionally depend on other factors, such as the signals received from other system components at step 515.

Once selected, the controller can then transmit control signals to one or more components of or devices associated with the bathing unit system, step 520. In some examples, the control signal causes a display in a mobile application associated with the bathing unit system to show the status of the spa cover such as with an image or icon (and/or text and/or sound).

In some examples, the control signals sent cause changes in the operation and/or appearance of the control panel 35 to which the light detection sensor 50 is affixed. In a specific example, the control panel 35 can be modified such that the sensitivity of the touch or presence-sensitive assembly 120 is modulated. In response to determining that the bathing unit system is in the closed state, the sensitivity of the touch or presence-sensitive assembly 120 can be reduced or eliminated. This is useful since touch screens tend to be sensitive to moisture and may erroneously detect a tactile input due to moisture conditions such as when drops of water fall onto the touch or presence-sensitive assembly 120. When the spa cover 80 is closed (or partially closed) it can be inferred that the bathing unit system 100 is not in use and thus that any tactile input that would be detected is erroneous and can be ignored.

In another example, the control signals are sent to cause changes in the brightness level of the control panel 35 to which the light detection sensor 50 is affixed. Determining a cover-off status can cause the brightness level of the control panel 35 to increase, e.g., to turn on from being off. That is, adjusting the level of brightness of the display screen includes setting the level of brightness of the display screen to a first brightness level in response to cover status conveying that the spa cover is in the open position and setting the level of brightness of the display screen to a second brightness level in response to the cover status conveying that the spa cover is in the closed position, the second brightness level being lower than the first brightness level

In some embodiments, the brightness level of the control panel 35 is affected by the ambient light sensor 450 (shown in FIG. 8). The ambient light sensor 450 is configured to detect the brightness level or luminosity of environmental light (e.g., day or night) independently of the light detection sensors 50, 55. The controller 34 can receive ambient light signals from the ambient light sensor (e.g., step 515 of FIG. 9) and send signals to the control panel 35 to automatically adjust the brightness of the display screen settings so that the keypad backlight luminosity fits with the current brightness level (e.g., cause the display screen 33 to be brighter if it is daytime and darker if it is nighttime). In addition to making the display screen easier to see for the user, reducing screen brightness can reduce energy usage due to efficient illumination of the user interface module 102. The processing unit is accordingly configured for receiving signals from the second ambient light sensor 450 that conveys measurements of the ambient lighting conditions for the spa system, and for adjusting the level of brightness of the display screen 33 at least in part by processing the spa cover status indicator and the signals received from the second light sensor.

In other embodiments, the ambient light sensor 450 can modulate the strength of the signal detected by the light detection sensor 50 (which can also include second light detection sensor 55) and thereby affect the operation of the control panel 35. The controller 34 can receive ambient light signals from the ambient light sensor 450 and based on those ambient light readings, cause the sensor to change a threshold of detection where the signal received by the light detection cover 50 determines that the spa cover 80 is on or off. That is, if the ambient light sensor 450 determines that it is dark outside, the controller 34 reduces the threshold of luminosity that is used to determine that the light detection sensor is detecting an open-cover state. In some embodiments, the memory 108 can include (and/or be configured to receive updates) information about the local sunset and/or sunrise times. Accordingly, the processing unit is configured for receiving signals from the second ambient light sensor 450 conveying measurements of the ambient lighting conditions for the spa system, deriving light calibration information at least in part by processing the measurements of the ambient lighting conditions for the spa system, and deriving the spa cover status indicator for the spa cover at least in part by processing the signals from the light detection sensor conveying the lighting conditions and the light calibration information.

Several different specific operations can be carried out by the bathing unit system once the determination is made of which specific one in the set of operational settings appropriate to the cover state should be selected. Closed-cover state operations can include blocking operational signals. That is, the controller 34 will block any signal that is received that would otherwise cause the system to move into an active use state. For example, a “start operation” signal sent from remote device, such as from a mobile application or from an auxiliary keypad, will not cause the jets 20 (of FIG. 1) to turn on if the light detection sensor indicates that the spa cover is closed. Such blocking of the start signals can prevent damage, such as from water overflowing the closed water receptacle.

An additional closed-cover state operational setting can cause a filtration sequence to be carried out only when the light detection sensor indicates that the spa cover is closed. Use of this setting optimizes energy consumption as well as protects the user from sanitizers used during a filtration sequence.

On the other hand, open-cover state operations can include adjusting the heating time required to reach a temperature if the light detection sensor signals an opened cover (e.g., cause the water to heat up slower).

Several different open-cover state operations can be carried out if the light detection sensor unexpectedly signals an opened cover. That is, the processing unit is configured to receive the information conveying current operational settings of the spa system and the spa cover status indicator for detecting inconsistencies between the current operational settings of the spa system and the spa cover. In response to the detection of specific inconsistencies, the processing unit can perform an inconsistency management process that includes at least one of issuing a notification to a user device conveying a presence of inconsistencies and causing the operational settings of the spa system to be set to standby settings or error settings.

For example, the bathing unit system 100 can include a prolonged rest mode that indicates that it is not used or should not be used. For example, this can include a vacation mode, hibernation mode, or a child lock mode. If the signal received from the light detection sensor indicates that the cover is off, the control signal sent may be a notification or alert sent to the user e.g., on a remote mobile device. Another alert can be sent when there is a conflict in the signal received from the light detection sensor and with other sensors. For example, if the light detection sensor indicates that the cover is off but no jets or water pump is in operation, the controller can send an alert such as “Please check if spa cover is opened due to wind”. The user can reattach the spa cover and resume safer, more energy efficient standby operations. Such an alert can also be sent in the case where there is a mismatch between the two light detection sensors 50, 55. If one of the sensors is sensing the presence of the cover while the other is sensing the absence of the cover, then an alert such as “Please check if spa cover is opened due to wind” can be sent to the user.

Transitioning the operational settings of the spa system to standby settings or error settings can include causing one or more spa components in the spa system to acquire a deactivate state. For example, if the light detection sensor indicates that the cover is on but other components are in use (e.g., the jets), signals can be sent to turn off the jets. In addition or instead of sending a notification to the user, the system may activate a visual indicator on or in proximity to the bathing unit system to convey the presence of inconsistencies in connection with the spa cover. For example, an LED on the control panel may light up, a flashing light on the spa skirt, but illuminate, or another visual or auditory signal may be employed.

### Moving From Open to Closed and Vice Versa

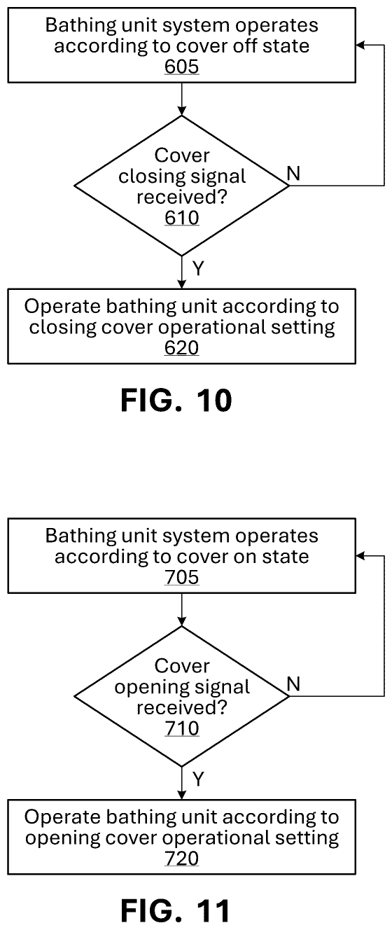

FIG. 10 illustrates a method used by the bathing unit system when the determination is made that the system is moved from a cover-off or in-use state to a cover-on or standby state. At step 605 the bathing unit operates according to the current usage settings. At step 610, the controller determines if the light detection sensor has sent a signal indicating that the cover is now on. If no signal has been received, the system continues operating at current settings, returning to step 605. If a closing-cover signal is received, the controller can select a closing-cover operational setting from the set of possible operations. For example, a filtration sequence can be started automatically after the end of a bathing session to clean the spa immediately to avoid propagation of bacteria.

In another example, interior lights, pumps and/or other accessories automatically shut of when the light detection sensor detects a transition from an open to a closed cover. This feature prevents waste of energy due to a user forgetting to close them down and simplifies the use of the spa. Another change can be the automatic illumination of perimeter or outside spa lights with the detection of a closed cover.

FIG. 11 illustrates a method used by the bathing unit system when the determination is made that the system is moved from a cover-on or standby state to a cover-off or in-use state. At step 705 the bathing unit operates according to the current usage settings. At step 710, the controller determines if the light detection sensor has sent a signal indicating that the cover is now off. If no signal has been received, the system continues operating at current settings, returning to step 705. If a closing-cover signal is received, the controller can select an opening-cover operational setting from the set of possible operations.

An opening-cover operational setting can include sending signals to automatically start one or more components of the bathing unit system, such as increasing illumination, starting jets, etc. This automatic start can be in accordance with one or more ambience settings in a set of ambience settings as described above. The operational setting can include causing spa accessories to aid in continuing the automatic opening of the cover. For example, a controlled electronic cylinder actuator can continue the opening processus once the system has detected the cover beginning its opening procedure. For additional information, the reader may refer for example to U.S. Pat. No. 8,644,960.

Accordingly, the signals from the light detection sensor convey the lighting conditions on the topside control panel and detect occurrences of transitions in the spa cover status from the closed position to the open position and vice versa. The transitions in the spa cover status are detected at least in part by processing changes in the lighting conditions on the topside control panel, and in response to detection of a specific transition in the spa cover status, a control signal as transmitted to cause the spa controller to implement specific corresponding operational settings in the spa system, depending on the specific transition detected. In some examples, when the specific transition in the spa cover status is from the closed position to the open position, the specific corresponding operational settings corresponds to a set of operational settings last used when operating the spa system (e.g., a last-used ambiance setting). When the specific transition in the spa cover status is from the open position to the closed position, the specific corresponding operational setting can correspond to a specific energy savings setting, such as one selected from a list of energy savings settings. The selection can be performed due to the specific transition and at least one other factor, such as user preference information, time of day information, day of week information, season information, energy cost information and weather information.

### Data Collection on Cover Opening Time, Durations and Spa Usage

In some embodiments, the data representing the cover-on and cover-off status over time can be saved and used for purposes such as administrative uses. The system can save (e.g., at the memory device 108) information relating to the times at which the system is in a cover-off state vs. cover-on state, the amount of time spent in each state, the times at which the transition from one state to the other is made, etc. In some embodiments, this historical data can be sent to a remote processor.

In one example, user safety can be enhanced by tracking the duration of a bathing session, e.g., duration when the light detection sensor determines the spa is in a cover-off state. If the duration of the current bathing session exceeds a safety window, an alert can be sent advising the user to exit the water to avoid health problems. If the system is in communication with weather information, an alert can be sent to the user to open or close the spa cover according to the weather, such as advising to close the cover if rain or a cold period is forecasted or to open the cover if the outside temperature will be very high.

An administrative use associated with the light detection sensor 50 is managing warranties. Hardware such as keypads and other accessories can deteriorate based on time when they are exposed to sunlight. For example, control panels 35 can be damaged (e.g., become leaky and no longer waterproof, undesirably change color) when exposed to excessive sun. Recording and verifying the time that the system is in the cover-on state can be used to validate a warranty relating to the control panel. For example, the controller 34 can transmit data indicating the time that the system is in the cover-on state to a third party.

Similarly, ultraviolet rays and debris from trees, snow, and ice can take a significant toll on the lifespan of a spa cover. To keep the cover in good health, the cover needs to be opened at certain intervals to remove moisture on or in it, and to remove debris. Recording and verifying the times that the system is in the cover-on vs. cover-off state can be used to validate a warranty relating to the spa cover. For example, the controller 34 can transmit data indicating the time that the system is in the cover-on vs. cover-off state to a third party.

Accordingly, the processing unit can transmit notifications to the one or more remote devices (e.g., to an app on a remote phone) conveying a hardware warranty expiry for the topside control panel by processing the historical data to derive an indication of sun exposure duration, and in response to the indication of sun exposure duration exceeding a threshold exposure limit, transmitting the notification conveying the hardware warranty expiry. In some instances, the processing unit may transmit at least part of the historical data to the remote device to validate a warranty of the spa cover based on a duration of the closed status of the spa cover.

An additional administrative function provided by the sensor cover data can include rentals and billing based on the spa usage. For example, an owner of a property with a bathing unit system can use the light detection sensor data to determine if and for how long the bathing unit was used. The owner can thus charge a usage fee, or excess usage fee, or provide a discount for no usage of the bathing unit.

In some embodiments, artificial intelligence (AI) can be used to maximize understanding of spa usage patterns and efficiency based on the collected data from the light detection sensor. For example, an AI can establish a spa usage pattern to be able to adjust maintenance and sanitation schedules, by increasing or decreasing their frequency or intensity. The AI can detect abnormal utilization of the spa over time and advise the owner of the spa.

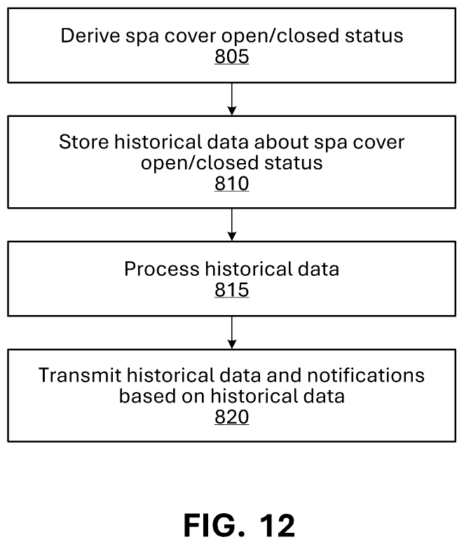

FIG. 12 illustrates a flowchart describing a method of controlling a spa system using historical data collected by the light detection sensor. At step 805, the processing unit derives spa cover status indicators conveying open and closed status information for the spa cover at least in part by processing signals received over time from the light detection sensor conveying the lighting conditions at the topside control panel. At step 810, in memory is stored historical data about the open or closed status of the spa cover conveyed by the spa cover status indicators on a computer readable medium. The spa system operates by adjusting operations of one of more components of the spa system at least in part by processing the historical data about the open or closed status of the spa cover, step 815. The system transmits at least part of the historical data to a remote device to derive information pertaining to usage information of the spa system and transmits notifications to one or more remote devices at least in part based on results derived by processing the historical data, step 820.

Adjusting the operations of one of more components of the spa system can include adjusting a sanitation schedule of the spa system. Transmitting notifications to one or more remote devices can include sending an alert to a user device in response to the historical data conveying a duration of the spa open status exceeding a safety threshold, or validating a warranty of the spa cover based on a duration of the closed status of the spa cover, or deriving a usage fee for the spa system. Transmitting notifications to one or more remote devices can include transmitting a notification conveying a hardware warranty expiry for the topside control panel by processing the historical data to derive an indication of sun exposure duration and in response to the indication of sun exposure duration exceeding a threshold exposure limit, transmitting the notification conveying the hardware warranty expiry.

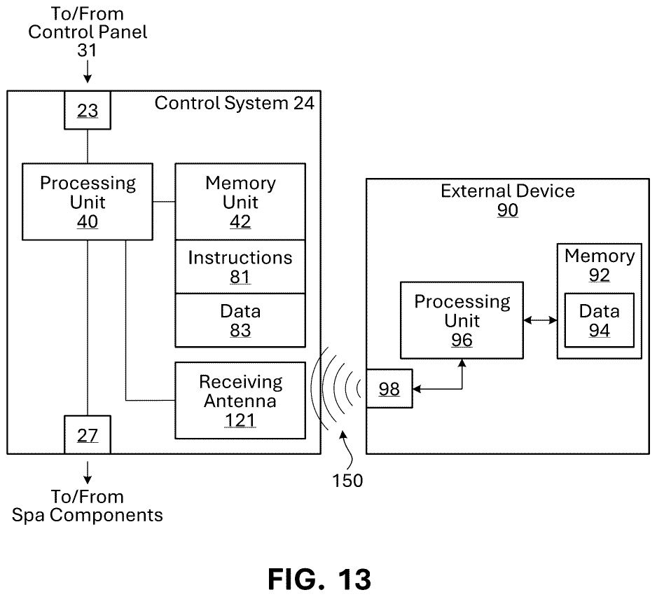

FIG. 13 shows a more detailed functional block diagram of the control system 24 of FIG. 1 in accordance with a non-limiting example of implementation together with a functional block diagram of an external device.

The control system 24 includes circuitry for controlling the operational settings of the different components of bathing unit system 100, including components 11, 13, 26, 28, 30. The circuitry can transmit a signal to the components of the bathing unit system via port 27 so as to control the operational setting of pumps, jets, heaters, etc.

In the embodiment depicted in FIG. 1, the circuitry for controlling the different components is shown as including a processing unit 40 and a memory device 42 that are in communication with one another. The processing unit 40, which may include one or more processors, may be configured for accessing and processing program instructions 81 and data 83 stored within the memory device 42 for enabling the control system 24 to control operational settings associated with the bathing unit system 100 at least in part based on those program instructions 81 in combination with signals received from an external device 90 and/or based on commands received from a user via the control panel 31 through communication port 23.

The program instructions 81 stored in the memory device 42, when executed by the processing unit 40, may also implement at least some functions of the control panel 31. For example, the program instructions stored in the memory device 42 may implement a menu driven interface through which a user can navigate and be presented on the display device with a set of selectable operational settings. Alternatively, functions pertaining to the control panel 35 may be implemented by a processor at the control panel 35 in any conventional manner. Functions of the type described above are well known in the field of bathing unit systems and therefore will not be described further here as they may be implemented in accordance with any suitable manner known in the art.

More specifically, information conveying different operational settings may be stored in the memory device 42 and may be pre-programmed, for example at the time of manufacturing of the control system 24 or through a user-or manufacturer-initiated software update process. Alternatively, or in addition to the above, one or more of the operational settings stored in memory device 42 may be programmed by a user through the control panel 35 or via another suitably programmed remote user computing device. The manufacturer of the bathing unit system 100, or a third party, may also offer pre-programmed operational settings for download to memory device 42. Operational settings may be programmed through the control panel 35 or via another suitably programmed remote user computing device in any suitable manner known in the art.

In addition, some or all the operational setting associated with bathing unit system 10 may be stored on a memory device external to memory device 42, such as for example on a portable memory device (not shown) or, alternatively, in a memory device 42 at the control panel 35. In a specific example, one or more operational settings may be stored in memory 92 in the external device 90 and may be provided to the control system 24 over the external communication network and then stored in memory device 42 as part of the set of operational settings.

The external device 90 and the control system 24 are configured to establish a link using an external communication network 150, between a port 98 of the external device 90 and the receiving antenna 121 of the control system 24. The link is for enabling the control system 24 to receive information from, and/or transmit information to, the external device 90. In particular, the external device 90 may be configured for transmitting data 94 that may be stored in a memory 92 of the external device 90. The memory 92 of the external device 90 may also store suitable instructions, which when executed by processing unit 96, allow for the transmittal of information to the control system 24 over the external communication network 150. Although the external communication network 150 could be a wired link, external communication network 150 is preferably implemented as a wireless communication link.

The person skill in the art will appreciate that many variations to the embodiments described in the present document art possible and will become apparent from a reading of the present document concurrently with the figures.

Certain additional elements that may be needed for operation of some embodiments have not been described or illustrated as they are assumed to be within the purview of those of ordinary skill in the art. Moreover, certain embodiments may be free of, may lack and/or may function without certain elements disclosed herein.

All references cited throughout the specification are hereby incorporated by reference in their entirety for all purposes.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps.

Unless otherwise defined, all technical and scientific terms used herein have the same meaning as commonly understood by one of ordinary skill in the art to which this disclosure pertains. In the case of conflict, the present document, including definitions will control.

As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

Although various embodiments of the invention have been described and illustrated, it will be apparent to those skilled in the art in light of the present description that numerous modifications and variations can be made. The scope of the invention is defined more particularly in the appended claims.

What is claimed is:

1. A topside control panel for a spa system including a water receptacle for holding water, a controller for controlling spa components in the spa system and a spa cover, the topside control panel being configured to be mounted to a peripheral wall of the water receptacle, the spa cover being configured to be in a closed position and an open position, wherein when in the closed position the spa cover is configured for concurrently covering the water receptacle and the topside control panel, the topside control panel comprising:
a. a panel body having an upper surface including a user interface for controlling operational settings of the spa system;
b. a light detection sensor positioned on the panel body, the light detection sensor being proximate the user interface and being configured to measure lighting conditions on the topside control panel; and
c. a processing unit in communication with the user interface and the light detection sensor, the processing unit being configured to:
i) receive signals from the light detection sensor conveying the lighting conditions on the topside control panel;
ii) derive a spa cover status indicator for the spa cover at least in part by processing the signals from the light detection sensor conveying the lighting conditions;
iii) in response to the spa cover status indicator conveying that the spa cover is in the closed position, operating the user interface in accordance with a closed cover operational process; and
iv) in response to a current cover status indicator conveying that the spa cover is in the open position, operating the user interface in accordance with an open cover operational process, the open cover operational process being different from the closed cover operational process.

2. The topside control panel of claim 1, wherein the user interface is a graphical user interface (GUI) and wherein the upper surface of the panel body includes a display screen displaying the GUI.

3. The topside control panel of claim 2, wherein the display screen is a touch screen and wherein the GUI presents user operable inputs for providing user commands for controlling at least some of the operational settings of the spa system.

4. The topside control panel as defined in claim 3, wherein the closed cover operational process includes disabling at least in part the user interface.

5. The topside control panel as defined in claim 4, wherein the open cover operational process includes transmitting a control signal to the spa controller for causing the spa controller to implement specific operational settings for the spa system conveyed by specific user commands provided via the user interface.

6. The topside control panel of claim 4, wherein disabling at least in part the user interface includes disabling the touch screen.

7. The topside control panel of claim 3, wherein operating the user interface in accordance with the closed cover operational process includes setting a sensitivity to touch of the touch screen to a first sensitivity level and wherein operating the user interface in accordance with the open cover operational process includes setting the sensitivity to touch of the touch screen to a second sensitivity level, the second sensitivity level being higher than the first sensitivity level so that there the touch screen is more sensitive when the spa cover is in the open position than when in the closed position.

8. The topside control panel of claim 3, wherein the processing unit is configured for adjusting a level of brightness of the display screen at least in part by processing the spa cover status indicator.

9. The topside control panel of claim 8, wherein adjusting the level of brightness of the display screen includes:
a. setting the level of brightness of the display screen to a first brightness level in response to the current cover status indicator conveying that the spa cover is in the open position; and
b. setting the level of brightness of the display screen to a second brightness level in response to the current cover status indicator conveying that the spa cover is in the closed position, the second brightness level being lower than the first brightness level.

10. The topside control panel of claim 8, wherein the processing unit is configured for:
a. receiving signals from a second light sensor conveying measurements of ambient lighting conditions for the spa system, and
b. adjusting the level of brightness of the display screen at least in part by processing the spa cover status indicator and the signals received from the second light sensor.

11. The topside control panel of claim 9, wherein the processing unit is configured for:
a. receiving signals from a second light sensor conveying measurements of ambient lighting conditions for the spa system;
b. deriving light calibration information at least in part by processing the measurements of ambient lighting conditions for the spa system; and
c. deriving the spa cover status indicator for the spa cover at least in part by processing the signals from the light detection sensor conveying the lighting conditions and the light calibration information.

12. (canceled)

13. (canceled)

14. The topside control panel of claim 1, wherein the light detection sensor is positioned on the upper surface of the panel body.

15. The topside control panel of claim 1, wherein the light detection sensor is positioned on a side surface of the panel body.

16. A control system for a spa system including a water receptacle for holding water and a spa cover, the spa cover being configured to be in a closed position and an open position, wherein when in the closed position the spa cover is configured for concurrently covering the water receptacle and a peripheral wall of the water receptacle, the control system including:
a. a topside control panel being configured to be mounted to the peripheral wall of the water receptacle, the topside control panel comprising:
i) a panel body having an upper surface including a user interface for controlling operational settings of the spa system; and
ii) a light detection sensor positioned on the panel body, the light detection sensor being proximate the user interface and being configured to measure lighting conditions on the topside control panel; and
b. one or more processors in communication with the topside control panel, the one or more processors being configured for:
i) receiving signals from the light detection sensor conveying the lighting conditions on the topside control panel;
ii) processing the signals from the light detection sensor conveying the lighting conditions to derive a spa cover status indicator for the spa cover;
iii) processing information conveying current operational settings of the spa system and the spa cover status indicator for detecting inconsistencies between the current operational settings of the spa system and the spa cover; and
iv) in response to detection of specific inconsistencies, performing an inconsistency management process, the inconsistency management process including at least one of:
1. issuing a notification to a user device conveying a presence of inconsistencies;
2. causing the operational settings of the spa system to be set to standby settings or error settings.

17. (canceled)

18. (canceled)

19. The control system of claim 16, wherein the presence of inconsistencies is detected when the spa cover status indicator conveys that the cover is in the open position and the operational settings of the spa system convey that the spa system is in a prolonged rest mode.

20. (canceled)

21. The control system of claim 16, wherein the presence of inconsistencies is detected when the spa cover status indicator conveys that the cover is in the closed position and the operational settings of the spa system convey that the spa system is in an active use mode, wherein the use active mode includes an activation of at least one of jets and water pump.

22. The control system of claim 16, wherein causing the operational settings of the spa system to be set to standby settings or error settings includes at least one of:
a. causing one or more spa components in the spa system to acquire a deactivate state; and
b. activating a visual indicator on or in proximity to the topside control panel to convey the presence of inconsistencies in connection with the spa cover, the visual indicator being in communication with the one or more processors.

23. The control system of claim 16, wherein the light detection sensor is positioned on the upper surface of the panel body or on a side surface of the panel body.

24. A topside control panel for a spa system including a water receptacle for holding water, a spa controller for controlling spa components in the spa system and a spa cover, the topside control panel being configured to be mounted to a peripheral wall of the water receptacle, the spa cover being configured to de displaced from a closed position to an open position and from the closed position to the open position, wherein when in the closed position the spa cover is configured for concurrently covering the water receptacle and the topside control panel, the topside control panel comprising:
a. a panel body having an upper surface including a user interface for controlling operational settings of the spa system;
b. a light detection sensor positioned on the panel body, the light detection sensor being proximate the user interface and being configured to measure lighting conditions on the topside control panel;
c. a processing unit in communication with the user interface and the light detection sensor, the processing unit being configured to:
i) receive signals from the light detection sensor conveying the lighting conditions on the topside control panel;
ii) processing the signals from the light detection sensor conveying the lighting conditions on the topside control panel to detect occurrences of transitions in a spa cover status from one of:
1. the closed position to the open position; and
2. the open position to the closed position;
the transitions in the spa cover status being detected at least in part by processing changes in the lighting conditions on the topside control panel;
iii) in response to detection of a specific transition in the spa cover status, transmitting a control signal for causing the spa controller to implement specific corresponding operational settings in the spa system, the specific corresponding operational settings being derived at least in part by processing the specific transition detected.

25. The topside control panel of claim 24, wherein when the specific transition in the spa cover status is from the closed position to the open position, the specific corresponding operational settings are derived from a specific ambience setting.

26. The topside control panel of claim 25, wherein the specific ambience setting conveys operational setting for spa components of at least two different types in the spa system, the at least two different types being selected from amongst lighting components, a pump, jets, audio components, video components and a heater.

27. (canceled)

28. (canceled)

29. (canceled)

30. (canceled)

31. The topside control panel of claim 24, wherein when the specific transition in the spa cover status is from the open position to the closed position, the specific corresponding operational settings correspond to a specific energy savings setting.

32. The topside control panel of claim 31, wherein the specific energy savings setting is selected from a plurality of energy savings settings, and wherein the selection is performed at least in part by processing the specific transition detected in combination with at least one other factor.

33. The topside control panel of claim 32, wherein the at least one other factor includes one of a user preference information, time of day information, day of week information, season information, energy cost information and weather information.

34. The topside control panel of claim 24, wherein the light detection sensor is positioned on the upper surface of the panel body or on a side surface of the panel body.

35. The topside control panel of claim 24, wherein the processing unit is configured for:
a. receiving signals from a second light sensor conveying measurements of ambient lighting conditions for the spa system;
b. deriving light calibration information at least in part by processing the measurements of ambient lighting conditions for the spa system; and
c. detecting occurrences of transitions in the spa cover status in part by processing the signals from the light detection sensor conveying the lighting conditions on the topside control panel and the light calibration information.

36. A topside combination for a spa system, the spa system including a water receptacle for holding water, a spa controller for controlling spa components in the spa system and a spa cover, the spa cover being configured to be in a closed position, in a fully opened position and in one or more partially opened positions, wherein when in the closed position the spa cover is configured for concurrently covering the water receptacle and a peripheral wall of the water receptacle, the topside combination comprising:
a. a first member configured to be mounted at a first location on the peripheral wall of the water receptacle, the first member including a topside control panel having an upper surface with a user interface for controlling operational settings of the spa system, wherein a first light detection sensor is positioned on the first member, the first light detection sensor being proximate the user interface and being configured to measure lighting conditions on the topside control panel;
b. a second member configured to be positioned at a second location on the peripheral wall of the water receptacle, the second location on the peripheral wall being spaced apart from the first location on the peripheral wall, the second member including a second light detection sensor configured to measure lighting conditions at the second location on the peripheral wall; and
c. a processing unit in communication with the first member and the second member, the processing unit being configured to:
i) receive signals from the first light detection sensor and the second light detection sensor conveying the lighting conditions on the topside control panel and the lighting conditions at the second location on the peripheral wall;
ii) processing the signals received in i) to derive a spa cover status indicator for the spa cover;
iii) in response to the spa cover status indicator conveying that the spa cover is in the closed position, transmitting control signals causing the spa controller to operate the spa system in accordance with a closed cover operational process; and
iv) in response to the spa cover status indicator failing to convey that the spa cover is in the closed position, transmitting control signals causing the spa controller to operate the spa system in accordance with one of an open cover operational process and a partially open cover operational process.

37. (canceled)

38. The topside combination of claim 36, wherein the spa cover status indicator for the spa cover is configured to convey that:
a. the spa cover is in the closed position;
b. the spa cover is in the open position; or
c. that the spa cover in one of the one or more partially opened positions.

39. The topside combination of claim 38, wherein the processing unit is configured to derive the spa cover status indicator conveying that the spa cover in the one of the one or more partially opened positions at least in part by processing differences between the lighting conditions at the second location and the lighting conditions on the topside control panel.

40. The topside combination of claim 36, wherein the first member is a first topside control panel, the second member comprising a second topside control panel, the second light detection sensor being part of the second control panel.

41.-54. (canceled)

55. A topside control panel for a bathing unit system, comprising:
a. a user interface including a touch screen;
b. a light detection sensor proximate the touch screen that is configured to detect if light falling on the light detection sensor on above or below a threshold; and
c. a processor electrically coupled to the touch screen and configured to receive a signal from the light detection sensor and thereby determine if a spa cover is in an open configuration or a closed configuration and modify the user interface in response.
